(19) United States
(12) Patent Application Publication
(10) Pub. No.: US 2026/0239141 A1
(43) Pub. Date: Aug. 13, 2026

(54) MIGRATION MANAGEMENT IN AN IAB COMMUNICATION SYSTEM

(71) Applicant: CANON KABUSHIKI KAISHA, Tokyo (JP)

(72) Inventors: Pierre VISA, Cesson-Sévigné (FR); Pascal LAGRANGE, Cesson-Sévigné (FR)

(21) Appl. No.: 19/470,680

(22) PCT Filed: Apr. 3, 2024
(86) PCT No.: PCT/EP2024/058985

§ 371 Date: Sep. 29, 2025

(30) Foreign Application Priority Data
Apr. 4, 2023 (GB) 2304998.4
Jul. 20, 2023 (GB) 2311145.3
Sep. 26, 2023 (GB) 2314755.6

(51) Int. Cl. H04W 36/08

(52) U.S. Cl. CPC H04W 36/087

(57) ABSTRACT

Methods and apparatus for use in managing a migration process for migrating a DU of an IAB node, from a source IAB topology managed by a source IAB donor Central Unit, CU, to a target IAB topology managed by a target IAB donor CU are disclosed. A method at the target IAB donor CU comprises: receiving, from the source IAB donor CU, a request for requesting DU migration of the DU of the IAB node from the source IAB donor CU to the target IAB donor CU; determining whether to accept or partially accept or reject the DU migration of the IAB node; after determining to accept or partially accept or reject the DU migration, sending, to the source IAB donor CU, a response indicating the target IAB donor CU has determined to accept or partially accept or reject the request for DU migration to the target IAB donor CU.

### FIELD OF THE INVENTION

The present invention generally relates to methods for use in a process for migrating nodes between Integrated Access and Backhaul, IAB, topologies of a wireless communication system involving mobile IAB nodes. Particularly, the present invention relates to a method for use in managing a migration process for migrating a Distributed Unit, DU, of an IAB node, for example a mobile IAB node, between IAB topologies.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems based on IEEE 802.11 standards, such as Wi-Fi.

The demand for network densification increases due to the rising number of users and higher throughput requirement.

Facing the issues of high deployment costs and time of the wired backhaul networks with network densification, 3GPP has proposed, from release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications (between base stations) may use the same radio/network resources as access communications (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate. However, millimeter waves are known to be subject to strong attenuations of signal strength in some weather conditions (rain, fog), and to blockage in case of obstacles located in the path between the emitter and the receiver.

To manage these potential radio link failures, a topological redundancy can be provided within the IAB framework, where multiple data paths are set up between the IAB base station directly connected to the core network (also referred to as the “IAB-donor”) and the IAB base station serving UEs (also referred to as the “access IAB-node” for the UEs). Several intermediate IAB base stations (also referred to as IAB-nodes) may be involved in each of the several paths between the IAB-donor and the access IAB-node, thus forming alternative data paths within a multi-hop IAB topology.

Besides, 3GPP has been considering inter-donor redundancy, where an IAB-node, referred to as a boundary IAB node, can access two different parent nodes connected to two different IAB-donors, with each of the IAB-donors managing a different IAB topology (also referred to as IAB network). The boundary IAB-node, even though belonging to a single IAB topology, i.e. belonging to a single IAB-donor for configuration and management, is thus able to route packets from a first IAB topology managed by a first IAB-donor to a second IAB topology managed by a second IAB-donor. The advantage of such inter-donor redundancy lies in the ability for the first IAB-donor to perform offloading by routing some of its packets through the second IAB topology, thus mitigating congestion issues or overcoming radio link failure issues that may arise in the first IAB topology.

There are other situations where an IAB-node becomes a boundary node. For example, in the case of partial migration of an IAB-node, decided by the IAB-donor, where the Mobile Termination (MT) of the IAB-node becomes connected to a single parent IAB-node belonging to another IAB topology controlled by another IAB-donor. This situation may also happen in the case of an IAB-node that experienced radio link failure (RLF) and that has recovered through a parent IAB-node belonging to another IAB topology. In those cases, the migrated IAB-node and its potential descendant IAB node(s) still belong to the initial IAB topology, and such partial migration may be called MT migration. In order to ensure that traffic can be routed through the other IAB topology, MT migration should be followed by traffic migration where the traffic related to the boundary node and its descendant IAB-nodes is routed through the other IAB topology up to the boundary node (i.e. the migrated IAB-node).

Stationary IAB-nodes should only require a single MT migration. Indeed, a backhaul link (defined between two successive IAB-nodes in the wireless backhaul) may experience radio failure due to fluctuations of radio conditions and, for IAB-nodes that do not move, it should be a temporary situation with possible link recovery after some time. Thus, it should not be required for such stationary IAB-nodes to perform multiple MT migrations in the same IAB topology or toward another IAB topology, and the transmission and the handling of multiple protocol messages can be avoided. For the same reason, the migration of the Distributed Unit (DU) of the IAB-node, leaving the control of the IAB-node to a new IAB-Donor, should not be required for stationary nodes. Moreover, it is noted that such DU migration, that may be called full migration, also involves the handover of UEs served by the migrating mobile IAB-node.

Urban environments are usually characterised by a high density of users along with the presence of a significant number of vehicles (e.g. public/private passengers transportation, goods delivery, food trucks . . . ). Some of these vehicles (e.g. buses, trams, trains), may have predictable routes and a significant number of collocated UEs (i.e. passengers' devices). 3GPP is considering that such vehicles could offer an opportunity to increase network coverage and connectivity to the UEs inside the vehicles, or even to UEs in proximity to the vehicles, by installing on these vehicles on-board base stations (or base station elements) that would act as mobile relays. These mobile relays would rely on 5G wireless backhaul (typically IAB, or Integrated Access & Backhaul) for connecting to a fixed donor device.

Thus, based upon the fixed IAB foundations of releases 16 and 17, 3GPP is now considering Mobile IAB systems and architecture, as a part of the release 18 framework, in order to address scenarios focusing on mobile IAB-nodes mounted on vehicles (such as buses, trains, taxis). In such scenarios, mobile IAB-nodes can be referred to as Vehicle Mounted Relays (VMR), providing 5G coverage/capacity to on-board and/or surrounding UEs.

The technical benefits of using VMRs include, among others, is the ability of the VMR to offer good radio link conditions to the nearby UEs. Additionally, comparing with a solution using a UE as relay (i.e. a Sidelink Relay solution), an IAB-node mounted on a vehicle is expected to have better RF/antenna capabilities, and to have less stringent power/battery constraints than a relay UE.

For a mobile IAB-node it may be worth performing multiple MT migrations or DU migration, as the connection to a parent IAB-node belonging to a first IAB topology may not occur again for a long time as the mobile IAB-node moves around or never again in the case where the mobile IAB-node moves away from the parent IAB-node. Besides, for flexible IAB network management, the DU migration for an IAB-node may be performed toward an IAB-donor different to the IAB-donor associated to the MT of this IAB-node.

Actually, the criteria for DU migration and MT handover differ: MT handover is driven by the radio conditions while DU migration decision may be based, for instance, on the available connectivity between IAB-donors and/or for load balancing purpose. Thus, the source IAB-donor may select a suitable target IAB-donor for the DU migration of an IAB-node based on its own criteria. However, the target IAB-donor may not be able to handle the migrating IAB-node and the served UEs, for example due to current load at the target IAB-donor and/or current load in the network. Therefore, some new mechanisms are required to allow the revocation or rejection of the DU migration of an IAB-node.

### SUMMARY

In accordance with a first aspect of the present invention, there is provided a method for use in managing a migration process for migrating a Distributed Unit, DU, of an Integrated Access Backhaul, IAB, node, from a source IAB topology managed by a source IAB donor Central Unit, CU, to a target IAB topology managed by a target IAB donor CU, performed at the target IAB donor CU. The method comprises: receiving, from the source IAB donor CU, a request for requesting DU migration of the DU of the IAB node from the source IAB donor CU to the target IAB donor CU; determining whether to accept or partially accept or reject the DU migration of the IAB node; after determining to accept or partially accept or reject the DU migration, sending, to the source IAB donor CU, a response indicating the target IAB donor CU has determined to accept or partially accept or reject the request for DU migration to the target IAB donor CU.

In accordance with a second aspect of the present invention, there is provided a method for use in managing a migration process for migrating a Distributed Unit, DU, of an Integrated Access Backhaul, IAB, node, from a source IAB topology managed by a source IAB donor Central Unit, CU, to a target IAB topology managed by a target IAB donor CU, performed at the source IAB donor CU. The method comprises: determining the DU of the IAB node is to be migrated to the target IAB donor CU; sending, to the target IAB donor CU, a request for requesting DU migration of the DU of the IAB node from the source IAB donor CU to the target IAB donor CU; receiving, from target IAB donor CU, a response indicating the target IAB donor CU has accepted or partially accepted or rejected the request for DU migration to the target IAB donor CU.

In accordance with a third aspect of the present invention, there is provided a method for use in managing a migration process for migrating a Distributed Unit, DU, of an Integrated Access Backhaul, IAB, node, from a source IAB topology managed by a source IAB donor Central Unit, CU, to a target IAB topology managed by a target IAB donor CU, performed at the target IAB donor CU. The method comprises: receiving, from the IAB node, a F1 setup request for requesting setup of a F1 connection between the target IAB donor CU and the IAB node and for indicating the F1 connection to be established relates to a request for DU migration of the DU of the IAB node to the target IAB donor CU; determining whether to accept or partially accept or reject the DU migration of the IAB node; sending a response indicating the target IAB donor CU has determined to accept or partially accept or reject the request for DU migration to the target IAB donor CU.

In accordance with a fourth aspect of the present invention, there is provided a method for use in managing a migration process for migrating a Distributed Unit, DU, of an Integrated Access Backhaul, IAB, node, from a source IAB topology managed by a source IAB donor Central Unit, CU, to a target IAB topology managed by a target IAB donor CU, performed at the source IAB donor CU. The method comprises: determining the DU of the IAB node is to be migrated to the target IAB donor CU; sending, to the IAB node, a request for establishing a F1 connection between the target IAB donor CU and the IAB node and for informing the target IAB donor CU the F1 connection to be established relates to a request for DU migration of the IAB node to the target IAB donor CU; receiving a response indicating the target IAB donor CU has accepted or partially accepted or rejected the request for DU migration to the target IAB donor CU.

In accordance with a fifth aspect of the present invention, there is provided a method for use in managing a migration process for migrating a Distributed Unit, DU, of an Integrated Access Backhaul, IAB, node, from a source IAB topology managed by a source IAB donor Central Unit, CU, to a target IAB topology managed by a target IAB donor CU, performed at the IAB node. The method comprises: receiving, from the source IAB donor CU, a request for establishing a F1 connection between the target IAB donor CU and the IAB node and for informing the target IAB donor CU the F1 connection to be established relates to a request for DU migration of the IAB node to the target IAB donor CU; sending, to the target IAB donor CU, a F1 setup request for requesting the setup of the F1 connection and for indicating the F1 connection to be established relates to a request for DU migration of the IAB node to the target IAB donor CU; receiving a F1 setup response indicating the target IAB donor CU has accepted or partially accepted or rejected the F1 setup request relating to the request for DU migration to the target IAB donor CU.

In an example, a decision to accept (i.e. fully accept) corresponds to a decision to accept the whole traffic (i.e. all of the traffic associated with the traffic profile(s) of the IAB node to be migrated) and all the UEs served by the IAB-node. A decision to partially accept corresponds to a decision to accept some or part of the traffic (i.e. accept some or a subset of the traffic profile(s) associated with the IAB node to be migrated) and/or a limited number or subset or some of the UEs served by the IAB node. Particularly, a decision to partially accept may correspond to a decision to accept the F1 setup connection with the IAB node but to accept some or part of the traffic (i.e. accept some or a subset of the traffic profile(s) associated with the IAB node to be migrated) and/or a limited number or subset or some of the UEs served by the IAB node.

In accordance with a sixth aspect of the present invention, there is provided an apparatus for an IAB donor CU as recited in claim 57 of the accompanying claims.

In accordance with a seventh aspect of the present invention, there is provided an apparatus for an IAB node as recited in claim 58 of the accompanying claims.

The method/apparatus in accordance with one or more embodiments of the present invention enables the target IAB donor CU to accept or partially accept or reject or revoke the DU migration (and thus, the subsequent handover of UEs served by the IAB node) and send a response indicating whether the DU migration has been accepted or rejected or revoked. The target IAB donor CU can inform the source IAB donor CU of its decision to accept or partially accept or reject or revoke DU migration by sending a message to the source IAB donor CU or to the IAB node (which can then inform the source IAB donor CU). With the target IAB donor CU sending a response to the source IAB donor CU to indicate the DU migration has been accepted or partially accepted or rejected, triggering activation of a second logical DU in the IAB node when DU migration is rejected can be avoided. With the target IAB donor CU sending a response to the IAB node to indicate the DU migration has been accepted or partially accepted or rejected, the F1 setup procedure will have already been completed which saves setup time when DU migration is accepted. Thus, the method/apparatus in accordance with one or more embodiments of the present invention enables the target IAB donor CU to reject or revoke the DU migration (and thus, the subsequent handover of UEs served by the IAB node) in the case the target IAB donor CU is not able to accommodate the IAB node DU and the traffic related to the served UEs (because of some lack of processing resources, or some lack of radio/network resources) and to inform the source IAB donor CU so that appropriate action can be taken.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by one or more processing units, cause the one or more processing units to carry out the method of any aspect or example described above and a computer readable storage medium carrying the computer program.

### BRIEF DESCRIPTION OF THE DRAWINGS

Different aspects of the invention will now be described, by way of example only, and with reference to the following drawings in which:

FIG. 1 is a schematic diagram of a communication system in which the present invention may be implemented according to one or more embodiments;

FIGS. 2a and 2b schematically illustrate stacks of some protocol layers involved in IAB operations;

FIG. 3 is a schematic diagram illustrating the format of a BAP Protocol Data Unit (PDU) or packet;

FIG. 4 is a block schematic diagram of an example wireless communication device in accordance with embodiments of the present invention;

FIG. 5 is a schematic diagram of an example IAB communication system (or IAB network system) in which embodiments and examples of embodiments of the present invention may be implemented;

FIG. 6 is a schematic and simplified diagram illustrating an example of IAB-node architecture enabling its DU migration from a source IAB topology to a target IAB topology;

FIG. 7 is a simplified diagram illustrating example message flows to perform the DU migration of an IAB-node including the handover of UEs served by the migrating IAB-node;

FIG. 8 is a simplified diagram illustrating example message flows, according to one or more embodiments of the invention, to allow a target F1 terminating donor-CU to partially accept or reject the DU migration of an IAB-node;

FIG. 9a is a simplified diagram illustrating an example message flow, according to one or more embodiments of the invention, of a procedure used by a RAN node CU to report configuration information to another RAN node CU;

FIG. 9b is a simplified diagram illustrating an example message flow, according to one or more embodiments of the invention, of a procedure used by a RAN node CU to manage the DU migration of a RAN node in coordination with another RAN node CU, including the signaling to partially accept, to reject or to revoke the DU migration;

FIG. 10a is a simplified diagram illustrating an example message flow, according to one or more embodiments of the invention, of a procedure to perform the activation of a logical DU in a RAN node, including the signaling to partially accept, to reject or to revoke by a RAN node CU the DU migration of the RAN node;

FIG. 10b is a simplified diagram illustrating an example message flow, according to one or more embodiments of the invention, of a procedure to setup a logical DU in a RAN node, including the signaling to partially accept, to reject or to revoke a DU migration of the RAN node by a RAN node CU;

FIG. 10c is a simplified diagram illustrating an example message flow of a procedure to remove a logical DU in a RAN node;

FIG. 11a is a flowchart of an example method in accordance with embodiments of the present invention, for managing, at the source F1 terminating donor-CU of an IAB-node, the DU migration of the IAB-node;

FIG. 11b is a flowchart of an example method in accordance with embodiments of the present invention, for managing, at the target F1 terminating donor-CU of an IAB-node, the DU migration of the IAB-node;

FIG. 12a is a flowchart of another example method in accordance with embodiments of the present invention, for managing, at the source F1 terminating donor-CU of an IAB-node, the DU migration of the IAB-node;

FIG. 12b is a flowchart of an example method in accordance with embodiments of the present invention, for managing, at an IAB-node its DU migration to a target F1 terminating donor-CU;

FIG. 12c is a flowchart of another example method in accordance with embodiments of the present invention, for managing, at a target F1 terminating donor-CU of an IAB-node, the DU migration of the IAB-node.

### DETAILED DESCRIPTION

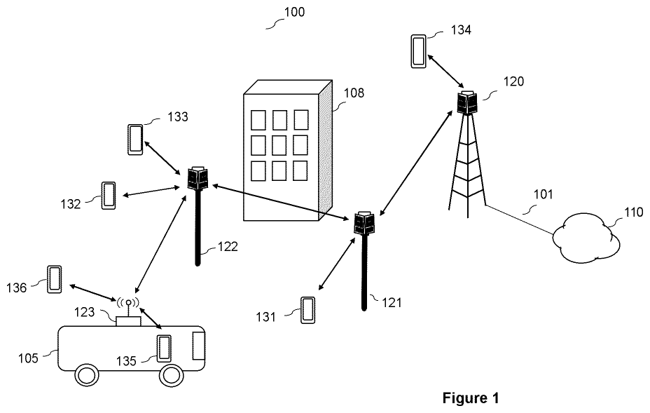

FIG. 1 illustrates an example communication system 100, in particular a mobile radio communication system such as a fifth-generation (5G) New Radio (NR) system including a wireless Integrated Access and Backhaul network supporting mobile IAB-node(s). Although in the following description, embodiments and examples of embodiments of the present invention will be described with respect to a 5G NR system, it will be appreciated that it is not intended that the present invention is limited to 5G NR systems and may be used in any wireless communication systems having a mobile base station. In particular, the following description predominantly uses terminology specific to 5G, but it should be appreciated that such terminology also applies to elements or processes performing an equivalent function in other communication systems.

The system 100 comprises a plurality of UEs (User Equipment) 132, 133, 131 and 134, a remote core network 110, a main Base Station 120, and two Integrated Access and Backhaul (IAB) stations or IAB nodes 121 and 122 (also referred to in the following as IAB-nodes), and a mobile Integrated Access and Backhaul (IAB) station 123 mounted on a vehicle 105 (for example, a bus, a train, a taxi, a car, etc.).

The main Base Station 120, also referred to as the IAB-donor 120, is connected to the core network 110 through a wired link 101, preferably an optical fiber or any other wired means. In embodiments and examples of embodiments of the invention, IAB-donor 120 is a 5G NR gNB with additional functionality to support IAB features, as defined in 3GPP TS 38.300 v 17.2.0 specification document.

In order to extend the network coverage of IAB-donor 120 and reach the remote UEs 132, 133 and 131, IAB stations 121 and 122, also referred to as IAB-nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 132 and 133 are operated at millimeter wave frequencies, which are highly sensitive to shadowing phenomena.

The IAB-donor 120 also serves UE 134, which is directly connected to it.

The mobile IAB station 123, also referred to as mobile IAB-node 123 or mIAB node 123, is an IAB-node that is mounted on vehicle 105 and provides network coverage and capacity extension, allowing the IAB-donor 120 to reach onboard remote UEs, like remote UE 135, as well as surrounding UEs or UEs in the vicinity of the IAB-node 123, like remote UE 136.

The IAB-donor 120 and the IAB-nodes 121, 122 and 123 are thus forming a backhaul network or IAB network, or IAB topology, which accommodates UEs 132, 133, 131, 134, 135 and 136. The terms IAB network and IAB topology will be used interchangeably in the following.

The specification of the Integrated Access and Backhaul (IAB) is spread over several 3GPP standard documents, including:
TS 38.300 RAN architecture (V17.2.0),
TS 38.321 MAC protocol (V17.2.0),
TS 38.331 Radio Resource Control (RRC) protocol (V17.2.0),
TS 38.340 Backhaul Adaptation Protocol Layer (V17.2.0),
TS 38.401 RAN architecture (V17.2.0),
TS 38.423 Xn Application Protocol (V17.2.0),
TS 38.473 F1 Application Protocol (V17.2.0).

As IAB-donor 120 and IAB-nodes 121, 122 and 123 are respectively connected to UEs 134, 131, 132, 133, 135 and 136, they are considered as Access IAB-nodes for their respectively connected UEs.

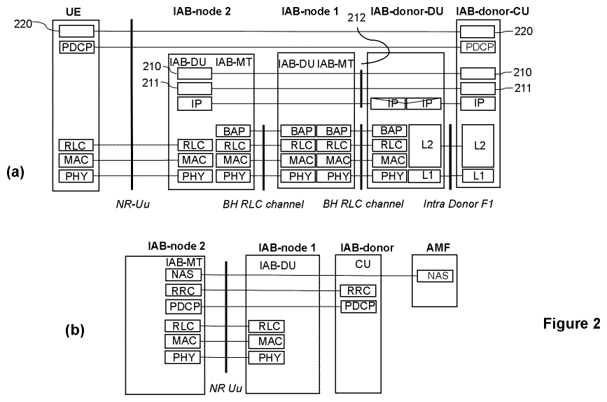

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or donor-CU (also referred to in the following as IAB-donor CU or IAB donor CU) hosts higher layer protocols, such as PDCP (Packet Data Convergence Protocol) and RRC (Radio Resource Control) protocols, for controlling operation of one or more DUs and each of the one or more IAB-donor-DUs or donor DUs (also referred to in the following as IAB-donor DU or IAB donor DU) includes lower layer protocols, such as the RLC, MAC and physical layer protocols. The IAB-donor-CU or donor-CU and IAB-donor DU or donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality as shown in FIGS. 2a and 2b discussed below.

The IAB nodes, which may serve multiple radio sectors, are wireless backhauled to the IAB-donor 120, via one or multiple hops over one or more intermediate IAB nodes. They form a directed acyclic graph (DAG) topology with the IAB-donor at its root.

The IAB nodes each consist of an IAB-DU (IAB-Distributed Unit) and an IAB-MT (IAB-Mobile Termination). The gNB-DU functionality on an IAB-node is also referred to as IAB-DU and allows the downstream (toward the UE) connection to the next-hop IAB or to a UE. The IAB-MT functionality includes, e.g., physical layer, layer-2, RRC and Non Access Stratum (NAS) functionalities to connect to the gNB-DU of an upstream IAB-node (including the IAB-donor 120 in which case it connects to the IAB-donor gNB-CU, hence to the core network 110, for instance for initialization, registration and configuration).

In this DAG topology, the neighbour node on the IAB-DU's interface is referred to as child node and the neighbour node on the IAB-MT's interface is referred to as parent node. The direction toward the child node is further referred to as downstream while the direction toward the parent node is referred to as upstream.

The IAB-donor 120 (e.g. the IAB-donor CU) performs centralized resource, topology and route management for the whole IAB topology. This includes configuring the IAB-nodes according to the network topology, e.g. in order to perform appropriate routing of data packets.

FIGS. 2a and 2b schematically illustrate stacks of some protocol layers involved in IAB operations.

F1 interface supports the exchange of signalling information (e.g. control traffic) between the endpoints, as well as the data transmission (e.g. user traffic transmission) to the respective endpoints. From a logical standpoint, F1 interface is a point-to-point interface between the endpoints.

In 5G NR, F1-C is the functional interface in the Control Plane (CP) between the IAB-donor-CU and an IAB-node-DU (e.g. of IAB-node 2), and between the IAB-donor-CU and an IAB-donor DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-node1 and then from IAB-node1 to IAB-node2).

In the User Plane, boxes 210 at the IAB-donor-CU and the IAB-node DU refer to the GTP-U layer and boxes 211 refer to the UDP layer. GTP-U stands for GPRS Tunnelling Protocol User Plane. GTP-U Tunnels are used to carry encapsulated PDUs and signalling messages between a given pair of GTP-U Tunnel Endpoints (refer to 3GPP TS 29.281 for more details), here boxes 210 at the IAB-donor-CU and the IAB-node DU. The well-known User Datagram Protocol (UDP) is a transport layer protocol providing a best effort datagram service and fit to use with an IP protocol.

In the Control Plane, boxes 210 indicate the F1AP (F1 Application Protocol) layer and boxes 211 indicate the SCTP (Stream Control Transmission Protocol) layer. The F1 Application Protocol (as defined in 3 GPP TS 38.473 and TS 38.401) provides signalling services between the IAB-donor-CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor-CU and the IAB-node DU as defined in 3GPP TS 38.401.

The transport between the IAB-donor DU and the IAB-donor-CU also uses an IP transport Layer over various media, like for example wires or optical fiber when the IAB-donor-CU is remote from the IAB-donor DU, or locally in a virtual instantiation of the IAB-donor-CU and the IAB-donor DU on the same physical machine. IAB-specific transport between IAB-donor-CU and IAB-donor-DU is specified in 3GPP TS 38.401.

L1 and L2 on the FIG. 2a stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

The IAB-DU's IP traffic is routed over the wireless backhaul via the BAP sublayer. In a downstream direction, upper layer packets are encapsulated by the BAP sublayer at the IAB-donor DU, thus forming BAP packets or packet data units (PDUs) or data packets. The BAP packets are routed by the BAP layer or entity (and corresponding BAP entities in the IAB-DU and IAB-MT) of the intermediate IAB-nodes, if any. The BAP packets are finally de-encapsulated by the BAP sublayer at the destination IAB-node (which may be an access IAB-node should the upper layer packets in the BAP packets be intended for a UE).

In an upstream direction, upper layer packets are encapsulated by the BAP sublayer at an initiator IAB-node (which may be an access IAB-node should the upper layer packets come from a UE), thus forming BAP packets or data units (PDUs) or data packets. The BAP packets are routed by the BAP layer (and corresponding BAP entities in the IAB-DU and IAB-MT) of the intermediate IAB-nodes, if any. The BAP packets are finally de-encapsulated by the BAP sublayer at the IAB-donor DU.

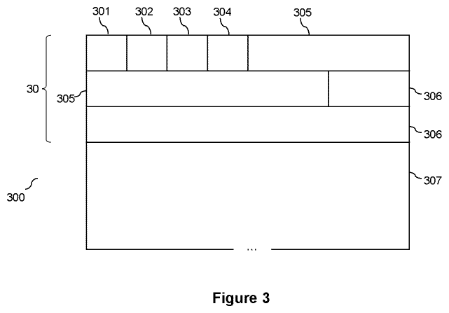

On the BAP sublayer, packets are routed based on the BAP routing ID, which is carried in the BAP header of the BAP packets, and which is set by the BAP sublayer of the emitting IAB-donor-DU or initiator IAB-node (e.g. a network node in the IAB network generating the BAP packets). FIG. 3 illustrates the format of a BAP Data Protocol Data Unit (PDU) or packet. It is specified in the standardized version paragraph 6.2 of 3 GPP TS 38.340 release 17.2.0.

The payload section 307 is usually an IP packet. The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e. on the BAP sublayer) of the destination IAB-node or IAB-donor DU for the BAP packet. For the purpose of routing, each IAB-node and IAB-donor DU in an IAB network is configured (by IAB-donor-CU of the IAB network) with a designated and unique BAP address. Field 306 carries a path ID identifying the routing path the BAP packet should follow to this destination in the IAB topology. For the purpose of routing, the routing paths, including their path ID, are configured (by IAB-donor-CU of the IAB network) in the IAB-nodes of the IAB network.

The BAP header is added to the packet when it arrives from upper layers to the BAP layer, and it is stripped off by the BAP layer when it has reached its destination node. The selection of the packet's BAP routing ID is configured by the IAB-donor-CU.

For instance, when the BAP packet is generated by a node, i.e. either by the IAB-donor-DU for downstream transmission or by an initiator (which may be an access IAB-node should the upper layer packets come from a UE) for upstream transmission, the BAP header with the BAP Routing ID is built by this node according to a configuration table defined in 3GPP TS 38.340. This table is called Downlink Traffic to Routing ID Mapping Configuration table in the IAB-donor-DU or Uplink Traffic to Routing ID Mapping Configuration table in the initiator IAB-node. In intermediate IAB-nodes, the BAP header fields are already specified in the BAP packet to forward.

As mentioned above, these configuration tables defining the BAP paths (hence the routing strategy and the configuration of the IAB-nodes given the IAB network topology) are usually defined by the IAB-donor-CU and transmitted to the IAB-nodes to configure them.

To transport messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS38.322. The MAC (Media Access Channel) protocol sublayer is responsible for selecting available transmission formats for the user data and for the mapping of logical channel to the transport channels. The MAC handles also a part of the Hybrid Automated Repetition request scheme. The MAC layer is detailed in TS 38.321. On the emitter or transmitter side, the MAC encapsulates the data packet issued from the RLC. It adds a header carrying information necessary to the MAC function. On the receiver side, the MAC decapsulates the data packet issued from the PHY sublayer, deletes its header and passes the remaining data to the RLC. The PHY sublayer provides an electrical interface to the transmission medium (the air) by converting the stream of information into physical modulation signals, modulating a carrier frequency at emitter side. At the receiver side, the PHY sublayer converts the physical modulation signals back to a stream of information. The PHY layer is described in TS 38.201, TS 38.211, TS 38.212, TS 38.213, TS 38.214.

To pass messages towards the user or control plane, two other sublayers are used in the UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The PDCP sublayer handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS 38.323.

SDAP sublayer 220 for the User Plane handles the Quality of Service. It is described in TS38.324. On the UE side, the SDAP sublayer exchanges the payload data with the user's application (voice, video, etc . . .—not shown in the Figure). On the IAB-donor-CU side, the SDAP sublayer exchanges the data with the Core Network 110 (Internet traffic, Cloud, etc . . . ).

RRC sublayer 220 for the Control Plane handles the configuration of the protocol entities of the User Plane protocol stack. It is described in TS38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e. its access IAB-node (for both CP and UP).

FIG. 2b comes from 3GPP TS 38.300 v17.2.0 and illustrates the protocol stack for the support of IAB-MT's RRC and NAS connections. The Non-Access Stratum (NAS) protocol handles the messages between the core network and a user equipment, or an IAB-node. It manages the establishment of communication sessions and maintains communications with the IAB-node or the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information for the IAB-node. AMF is only responsible for handling connection and mobility management tasks.

The IAB-MT establishes signalling Radio Bearers SRBs (bearers carrying RRC and NAS messages) with the IAB-donor-CU. These SRBs are transported between the IAB-MT and its parent node(s) over NR-Uu interface(s).

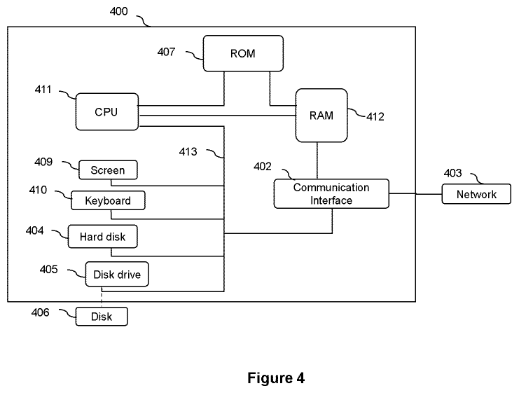

FIG. 4 shows a schematic representation of an example communication device (apparatus) or station, in accordance with one or more example embodiments of the present disclosure.

The communication device 400 may be a device such as a micro-computer, a workstation or a light portable device. The communication device 400 may comprise a communication bus 413 to which there are preferably connected:
a central processing unit 411, such as a microprocessor, denoted CPU. The central processing unit 411 may be a single processing unit or processor or may comprise two or more processing units or processors carrying out the processing required for the operation of the communication device 400. The number of processors and the allocation of processing functions to the central processing unit 411 is a matter of design choice for a skilled person;
memory for storing data and computer programs containing instructions for the operation of the communication device 400. The computer programs may contain a number of different program elements (modules) or sub-routines containing instructions for a variety of operations and for implementing the methods in accordance with one or more embodiments of the invention; and
at least one communication interface 402 for communicating with other devices or nodes in a communication system, such as the communication system of FIG. 1. The at least one communication interface 402 may be connected to the radio communication network 403, such as a wireless communication network for 5G NR (e.g. according to release 17 and/or subsequent releases), over which digital data packets or frames or control frames are transmitted. The frames are written from a FIFO sending memory in RAM 412 to the communication interface for transmission or are read from the communication interface for reception and writing into a FIFO receiving memory in RAM 412 under the control of a software application running in the CPU 411.

Each of a donor CU, a donor DU, an IAB node and a UE may be implemented in such a communication device/apparatus 100.

The memory may include:
a read only memory 407, denoted ROM, for storing computer programs for implementing methods in accordance with one or more embodiments of the invention;
a random-access memory 412, denoted RAM, for storing the executable code of methods according to one or more embodiments of the invention as well as the registers adapted to record variables and parameters necessary for implementing methods according to one or more embodiments of the invention.

Optionally, the communication device 400 may also include the following components:
a data storage means 404 such as a hard disk, for storing computer programs for implementing methods according to one or more embodiments of the invention;
a disk drive 405 for a disk 406, the disk drive being adapted to read data from the disk 1106 or to write data onto said disk;
a screen 409 for displaying decoded data and/or serving as a graphical interface with the user, by means of a keyboard 410 or any other input/output means.

In an example arrangement, the communication bus 413 provides communication and interoperability between the various elements included in the communication device 400 or connected to it. The representation of the bus is not limiting and in particular, the central processing unit is operable to communicate instructions to any element of the communication device 400 directly or by means of another element of the communication device 400.

The disk 406 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the communication device, possibly removable and adapted to store one or more programs whose execution enables a method according to embodiments of the invention to be implemented.

The executable code may optionally be stored either in read only memory 407, on the hard disk 404 or on a removable digital medium such as for example a disk 406 as described previously. According to an optional variant, the executable code of the programs can be received by means of the communication network 403, via the interface 402, in order to be stored in one of the storage means of the communication device 400, such as the hard disk 404, before being executed.

The central processing unit 411 may be adapted to control and direct the execution of the instructions or portions of software code of the program or programs according to the invention, which instructions are stored in one of the aforementioned storage means. On powering up, the program or programs that are stored in a non-volatile memory, for example on the hard disk 404 or in the read only memory 407, are transferred into the random-access memory 412, which then contains the executable code of the program or programs, as well as registers for storing the variables and parameters necessary for implementing the invention.

In an example implementation, the communication device (apparatus) is a programmable device/apparatus which uses software to implement the invention. Instructions may be executed by one or more processors of the apparatus, such as one or more digital signal processors (DSPs), general purpose microprocessors, application specific integrated circuits (ASICs), field programmable logic arrays (FPGAs), or other equivalent integrated or discrete logic circuitry to implement the invention for a network node (e.g. IAB node, IAB donor CU). Accordingly, the term “central processing unit” as used herein may refer to any of the foregoing structure or any other structure suitable for implementation of the techniques described herein. However, alternatively, the present invention may be implemented in hardware (for example, in the form of an Application Specific Integrated Circuit or ASIC or other logic element).

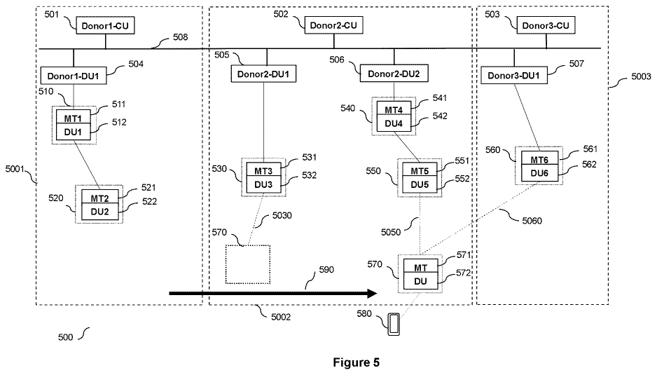

FIG. 5 illustrates an example of an IAB communication system (or IAB network system) 500 in which embodiments and examples of embodiments of the present invention may be implemented. In one example implementation, the radio links between the IAB nodes and between the IAB nodes and the IAB donor DUs (referred to as BH radio links) are operated over the millimeter wave frequency band (i.e. above 30 GHz), which is highly sensitive to radio channel disturbance. An IAB network will also be referred to as an IAB topology or topology and so in this application, the terms IAB network and IAB topology and topology will be used interchangeably.

IAB communication system 500 is composed of three IAB networks or IAB topologies 5001, 5002, and 5003 with each IAB topology comprising a set of IAB nodes (e.g. the set may comprise a plurality of IAB nodes or at least one IAB node) and an IAB-donor-CU for controlling or managing the plurality of IAB nodes. The set of IAB nodes may include one or more IAB-nodes, such as initiator IAB-nodes which generate BAP packets and also intermediate or relay IAB-nodes. Each of the IAB nodes communicate with at least one other IAB node over a wireless backhaul (BH) link. Although FIG. 5 shows three IAB topologies 5001, 5002, and 5003, the present invention is not limited to three IAB topologies and may be implemented in an IAB communication system comprising more than two IAB topologies with each topology comprising a set of IAB nodes and an IAB donor-CU as discussed above.

As discussed above, each IAB node comprises a Mobile Termination (MT) part or unit, controlled and configured by the IAB donor using RRC messaging as defined in 3GPP TS 38.331, and a Distributed Unit (DU) part, controlled and configured by the IAB donor using F1-AP messaging as defined in 3GPP TS 38.473. For example, IAB-node 510 comprises a MT part or unit 511 and a DU part 512.

IAB topology 5001 includes IAB-donor-CU 501 (identified as Donor1-CU in FIG. 5), and its associated IAB-donor-DU 504 (identified as Donor1-DU1 in FIG. 5), and a plurality of IAB-nodes 510 and 520, similar to IAB-nodes 121 and 122.

IAB topology 5002 includes IAB-donor-CU 502 (identified as Donor2-CU in FIG. 5), its associated IAB-donor-DUs, IAB-donor-DU 505 (identified as Donor2-DU1 in FIG. 5) and IAB-donor-DU 506 (identified as Donor2-DU2 in FIG. 5), and a plurality of IAB-nodes 530, 540, 550, similar to IAB-nodes 121 and 122, and IAB-node 570, that may be similar to mobile IAB-node 123. All IAB-nodes can be access nodes serving UEs like the UE 580 served by the mobile IAB-node 570. The IAB topology 5002 is transparent for the UE 580 that connects to the donor-CU 502 through the DU part or unit 572 of the mobile IAB-node 570. Although FIG. 5 shows only one UE 580, it will be appreciated that there will be a plurality of UEs connected to the network nodes of the IAB communication system 500.

IAB topology 5003 includes IAB-donor-CU 503 (identified as Donor3-CU in FIG. 5), and its associated IAB-donor-DU 507 (identified as Donor3-DU1 in FIG. 5), and an IAB-node 560, similar to IAB-nodes 121 and 122.

A wired backhaul IP network interconnects the IAB-donor-CUs 501, 502, and 503, and the IAB-donor-DUs 504, 505, 506 and 507 through the wired backhaul 508. For instance, this wired backhaul 508 consists of optical fiber cables.

IAB-Donor-CU 501, IAB-Donor-DU 504 and IAB-nodes 510 and 520 are part of the same IAB network or IAB topology 5001, which is configured and managed or controlled by IAB-Donor-CU 501.

IAB-Donor-CU 502, IAB-Donor-DUs 505 and 506, and IAB-nodes 530, 540, 550 are part of the same IAB network or IAB topology 5002, which is configured and managed or controlled by IAB-Donor-CU 502.

IAB-Donor-CU 503, IAB-Donor-DU 507, and IAB-node 560 are part of the same IAB network or IAB topology 5003, which is configured and managed or controlled by IAB-Donor-CU 803.

Each IAB-DU and IAB Donor DU supports wireless communication in a coverage area(s) referred to as cell(s) (not shown in FIG. 5). In other words, each IAB-DU and IAB Donor DU is associated with cell(s). Wireless communication devices (such as UEs, or other IAB-nodes) located within a cell may establish communication links with the node (i.e. IAB-DU or IAB Donor DU) serving the cell in order to communicate with other devices (e.g. other UEs, IAB-nodes, servers providing access to the Internet, etc.) via the node.

It is assumed that the mobile IAB-node 570 had initially a single parent IAB-node 520, and that IAB-node 570 belongs to the IAB topology 5001 controlled by the IAB-Donor-CU 501. The IAB-Donor-CU is thus operating as the F1 terminating donor-CU (which may also be referred to as a F1-terminating IAB-donor-CU or F1 donor-CU). When moving, and in view of its proximity to IAB topology 5002, in particular to the IAB-node 530 when the mobile IAB-node 570 is in the position shown in dotted lines in FIG. 5, the mobile IAB-node 570 may be able to establish a wireless BH link 5030 with the IAB-node 530. Such a BH link is possible for a stationary IAB-node, and it is very likely to happen for a mobile IAB-node like IAB-node 570, moving, for instance, in the direction of the IAB topology 5002 (shown by arrow 590 in FIG. 5).

Then, the F1 donor-CU 501 may have decided to perform the migration of the MT part 571 of the IAB-node 570 toward the IAB topology controlled by the donor-CU 502, which became the non-F1 terminating donor-CU (which may also be referred to as a non-F1-terminating IAB-donor-CU or non-F1 donor-CU, or RRC terminating donor-CU) for the IAB-node 570 (i.e. the MT part 571 of the IAB-node 570 is migrated toward the parent IAB-node 530). For this purpose, the F1 donor-CU 501 may have initiated the inter-CU Topology Adaptation procedure described in TS 38.401 V17.2.0 section 8.17.3.1 or section 8.17.3.2 (when the IAB-node 570 has descendant IAB-nodes). As a result, the IAB-node 570 still belongs to the IAB topology 5001, with its F1 connection to the donor-CU 501, but its RRC connection is now to the donor-CU2 502. After that procedure, the IAB-donor-CU 501 may request the migration toward the IAB topology 5002 (i.e. through the donor-DU 505) of the backhaul traffic (e.g. user traffic, control traffic) related to the IAB-node 570. In this case, the donor-CU 501 triggers the IAB transport migration management procedure specified in TS 38.423 V17.2.0 section 8.5.2. In the IAB communication system, all traffic communicated over backhaul links uses a F1 interface (F1-C or F1-U) between an IAB donor CU and an IAB-DU. Thus, the traffic or backhaul traffic that is offloaded or migrated is F1 traffic and can include control and user traffic.

While the mobile IAB-node 570 is still moving in the direction shown by arrow 590, the MT part 571 of the IAB-node 570 may then have been migrated by the non-F1 donor-CU 502 toward the parent IAB-node 550, using the backhaul link 5050 between the IAB-node 550 and the IAB-node 570. For this purpose, the non-F1 donor-CU 502 may have applied the intra-CU topology adaptation procedure described in TS 38.401 V17.2.0 section 8.2.3.1 (or section 8.17.3.2), resulting in a consecutive MT migration (or another MT migration to another IAB-node) of the IAB-node 570 with a new single parent IAB-node 550. Still, the IAB-node 501 has its F1 connection with the donor-CU 501 and its RRC connection with the donor-CU2 502.

After being informed to use the donor-DU 506 instead of donor-DU 505 to route the F1 traffic related to the IAB-node 570, the donor-CU 501 may request the migration of the traffic related to the IAB-node 570 toward the IAB topology 5002. In this case, the donor-CU 501 triggers the IAB transport migration management procedure specified in TS 38.423 V17.2.0 section 8.5.2.

While further moving, this time in the direction of IAB topology 5003 controlled by the donor-CU 503, the IAB-node 570 may become in a position where a backhaul link 5060 with the IAB-node 560 may have a better quality than the backhaul link 5050 with the IAB-node 550. Thus, the donor-CU 502 may apply the inter-CU Topology Adaptation procedure described in TS 38.401 V17.2.0 section 8.17.3.1 or 8.17.3.2. After this consecutive MT migration, the IAB-node 501 still belongs to the IAB topology 5001, with its F1 connection with the donor-CU 501, but its RRC connection is now with the donor-CU 503 and thus, the donor-CU 503 becomes the non-F1 terminating donor-CU (or non-F1 donor-CU, or RRC terminating donor-CU). However, the donor-CU 501 has to be informed of the new non-F1 donor-CU 503 for the IAB-node 570 and of the new donor-DU 507 to redirect the offloaded traffic (F1 traffic, control and user traffic) through the donor-DU 507 instead of donor-DU 506.

In all the MT migration cases described above, the UE 580 still connects to the donor-CU 501 through the DU part or unit 572 of the mobile IAB-node 570. In case the IAB-node 570 has some child IAB-node(s), such child IAB-node still belongs to the IAB topology 5001, and it is still fully controlled (through F1 and RRC connections) by the donor-CU 501.

At any state of migration of the MT part 571 of the IAB-node 570, thus regardless of whether the MT part 571 of the IAB-node 570 has migrated to IAB topology 5002 or another IAB topology and so regardless of whether the IAB-node 570 has a non-F1 terminating donor-CU and if it does, whether it's the non-F1 terminating donor-CU 502 or another donor-CU, the F1 donor-CU 501 may decide to perform the migration of the DU part of the IAB-node 570. The reason for performing DU migration may be to reduce the processing load at the F1 donor-CU 501, or because the IAB-node 570 is geographically far from the F1 donor CU 501 and close to an area where there is no more Xn connectivity between the F1 donor CU 501 and a target donor-CU. After the decision to perform the DU migration of the IAB-node 570, the F1 donor-CU 501 has also to decide toward which donor-CU (which is referred to as the target F1 donor-CU) the DU migration shall be performed. It may be a DU migration toward the current non-F1 terminating donor-CU (i.e. the default choice) if there is a current non-F1 terminating donor-CU and in this case the non-F1 terminating donor-CU becomes the target F1 donor-CU, or to another target F1 donor-CU. It is optimal for an IAB-node to have the same donor-CU controlling both the MT and the DU of the IAB-node, as it avoids to setup the transport migration from one IAB-topology to another IAB-topology for the backhaul traffic from/to the IAB-node. However, the reason to perform the DU migration to a donor-CU different from the current non-F1 terminating donor-CU 502, may be to anticipate the next move of the IAB-node in the direction of another IAB topology. For instance, the IAB-node 570 may become in a position where a backhaul link 5060 with the IAB-node 560 may have a better quality than the backhaul link 5050 with the IAB-node 550. As the IAB-node 560 belongs to the IAB topology 5003 controlled by the donor-CU 503, the donor-CU 503 may soon become the non-F1 terminating donor-CU for the IAB-node 570 (after a new consecutive MT migration), and it is natural to select the donor-CU 503 as the target F1-terminating donor-CU for the IAB-node 570. Besides, if the IAB-node 570 is mobile and its trajectory is predictable (e.g. for a bus or a train), the F1 donor-CU 501 may be aware of a suitable target F1-donor-CU controlling cells through which the IAB-node 570 will soon connect to the network. For instance, while the non-F1 terminating donor-CU of the IAB-node 570 is the donor-CU 502, the F1 donor-CU may decide the DU migration of the IAB-node 570 should be directly toward the donor-CU 503, as the IAB-node 570 may rapidly cross and not stay in the IAB topology 5002 controlled by the donor-CU 502. To not perform the DU migration toward the donor-CU 502, and instead perform DU migration toward the donor-CU 503, will avoid protocol messages for the intermediate DU migration of the IAB-node 570. When DU migration is performed, handover of the UEs served by the IAB-node 570 must also be performed. Thus, to not perform the DU migration toward the donor-CU 502 will also avoid the intermediate handover of UEs served by the IAB-node 570 to the donor-CU 502, before a new DU migration and UEs handover toward the donor-CU 503.

The procedure to perform a DU migration and the UEs handover toward a selected target F1 donor-CU is described in more detail with reference to the subsequent figures.

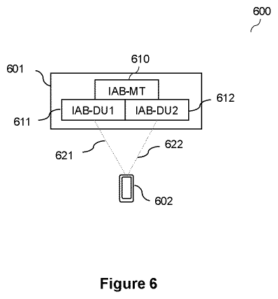

FIG. 6 illustrates an example of IAB-node architecture 600 which enables migration of the DU of the IAB-node (DU migration) from a source IAB topology to a target IAB topology.

The IAB node 601, which may be a mobile IAB-node like the IAB-node 570, is composed of an IAB-MT part or unit IAB-MT 610 (like the MT part or MT 571 of the IAB-node 570 of FIG. 5), a part or unit IAB-DU1 611, and a part or unit IAB-DU2 612. IAB-DU1 and IAB-DU2 are two logical DU entities (also referred to as logical DUs) that share the same hardware for the BAP, RLC, and MAC layers. In one example, they share the same physical layer (i.e. the same hardware resources), while in another example they rely on separated physical layers. At the DU migration of the IAB-node 601, both logical DUs are active: one of the logical DU terminates the F1 interface with a source F1 donor-CU (like donor-CU 501 in FIG. 5), while the other logical DU terminates the F1 interface with a target F1 donor-CU (like donor-CU 502 or 503 in FIG. 5). Otherwise (i.e. when DU migration is not to be performed), only one logical DU is sufficient for IAB operations. As an example and with reference to the IAB communication system of FIG. 5, the F1 terminating donor CU of the IAB node 601 (i.e. IAB node 570) may be donor-CU 501 which is thus operating as the source F1 donor-CU. The source F1-donor CU 501 may identify IAB donor-CU 503 as a target F1 donor-CU. Alternatively, for an IAB node which is connected to parent IAB-node or parent IAB donor-DU of the IAB topology 5001 managed by the donor-CU 501 as the F1 terminating donor CU and which is stationary but is in proximity to or in the vicinity of one or more IAB nodes in a neighbouring IAB topology, such as IAB topology 5002, the source F1-donor CU 501 may determine that IAB donor-CU 502 is a suitable target F1 donor-CU when source F1-donor CU 501 determines (e.g. based on signal measurements performed at the IAB-node on radio signals received at the IAB-node from all IAB-nodes in proximity to the IAB-node and which may include IAB-nodes in the neighbouring IAB topology 5002) that the IAB-node may soon connect to an IAB-node in the neighbouring IAB topology 5002.

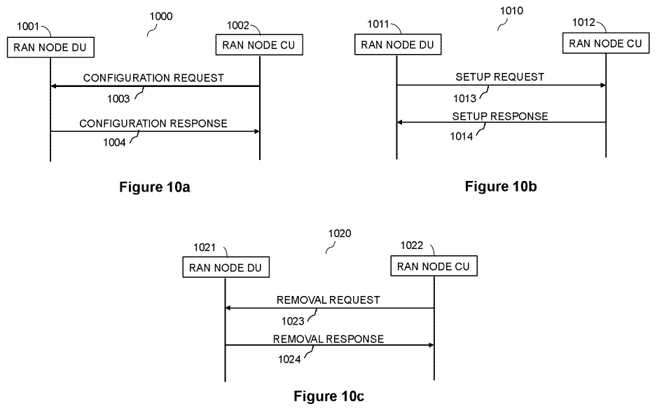

Before the DU migration, a UE 602 (like UE 580 of FIG. 5) is for instance connected to the source F1 donor-CU 501 through the logical DU IAB-DU1 611 with the access link 621 in the cell served by the logical DU IAB-DU1 611, and the logical DU IAB-DU2 612 is deactivated. At the DU migration, the logical DU IAB-DU2 612 is activated and connects to the target F1 donor-CU 502, to which the UE 602 may also connect through the logical DU IAB-DU2 612 with the link 622 in the cell served by the logical DU IAB-DU2 612. The activation of the logical DU IAB-DU2 612 may be triggered by the source F1 donor-CU and executed with the procedures described with reference to the FIGS. 10a and 10b. Once the handover of UE 602 is completed from a cell controlled by the logical DU IAB-DU1 611 to a cell controlled by the logical DU IAB-DU2 612, the logical DU IAB-DU1 611 may be deactivated. The deactivation may be triggered by the source F1 donor-CU 501 with the procedure described with reference to FIG. 10c, after the detection of the completion of the handover for all UEs served by the IAB-DU1 611.

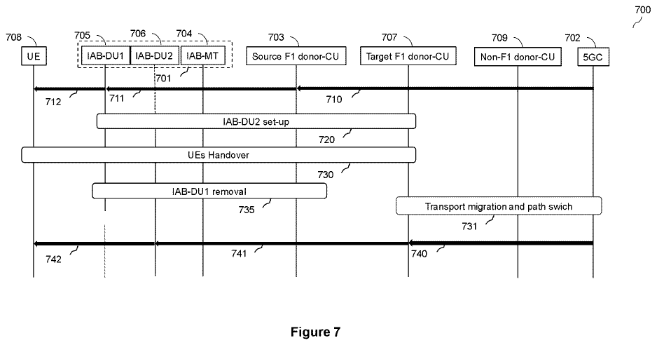

FIG. 7 is a schematic and simplified diagram 700 illustrating some example message flows, to perform the DU migration of an IAB-node, with or without (multiple) MT migration(s), and which includes the setup of data path(s) for packets routing between the target F1 donor-CU and the IAB-node through an IAB topology controlled by the non-F1 donor-CU/RRC terminating donor-CU of the IAB-node.

This FIG. 7 shows a UE 708 like the UE 580, a source F1 donor-CU 703 like the donor-CU 501, a target F1 donor-CU 707 like the donor-CU 503, a non-F1 donor-CU 709 like the donor-CU 502, the core network (5GC) 702 like the core network 110 of FIG. 1. This FIG. 7 also shows an IAB-node 701 that may be a mobile IAB-node like the IAB-node 570 composed of a MT part or unit IAB-MT 704, a DU part or unit IAB-DU1 705 (e.g. source or first logical DU entity or DU), and a DU part or unit IAB-DU2 706 (e.g. target or second logical DU entity or DU). Each of the first 705 and second 706 logical DU entities serve one or more cells which are identified by identifiers (e.g. Physical Cell Identifier (PCI), New Radio Cell Group Identifier (NCGI)). The cell(s) of the IAB-DU1 705 are identified by different values for the identifiers (e.g. Physical Cell Identifier (PCI), New Radio Cell Group Identifier (NCGI)) compared to the values for the identifiers for the cell(s) of the IAB-DU2 706. IAB-DU1 705 and IAB-DU2 706 are two logical DU entities that share the same hardware for the BAP, RLC, and MAC layers. In one example, they share the same physical layer (i.e. the same hardware resources), while in another example they rely on separated physical layers. The non-F1 donor-CU 709 for the IAB-node 701 may be the source F1 donor-CU 703 itself (e.g. donor-CU 501) if the IAB-MT 704 was not migrated. The non-F1 donor-CU for the IAB-node 701 may be the target F1 donor-CU 707 (e.g. donor-CU 503) if the IAB-MT 704 was previously migrated toward the target F1 donor-CU 707, or another donor-CU (e.g. donor-CU 502) if the IAB-MT 704 was previously migrated toward this other donor-CU (e.g. donor-CU 502).

At the beginning of the flow, the IAB-node 701 belongs to the source IAB topology controlled by the source F1 donor-CU 703. The UE 708 is served by the IAB-node 701 through a cell of IAB-DU1 705 (e.g. the DU of the IAB-node 701 has an active IAB-DU1 705 having a F1 connection with the source F1 IAB donor CU 703), while the logical IAB-DU2 706 is inactive. The user data in the downstream direction are provided by the 5GC 702 to the source F1 donor-CU 703 through the bearer 710, then the data are transmitted to the logical DU IAB-DU1 705 of the IAB-node 701 through the backhaul bearer 711, and finally to the UE 708 through the data radio bearer 712. The backhaul bearer 711 may be established in the source IAB topology controlled by the source F1 donor-CU 703, or in the IAB topology controlled by the non-F1 donor-CU 709 of the IAB-node 701 (if the IAB-MT 704 was previously migrated toward this non-F1 donor-CU). User data in the upstream direction (not represented in the figure) are transmitted through similar bearers in the opposite direction.

The IAB-MT 704 may send measurement reports (not represented in the FIG. 7) to its non-F1 terminating donor-CU 709 as the result of the measurements regularly performed by IAB-MT 704 on signals received from the serving cell and one or more target cells, such as the Signal Synchronization Block (SSB) transmitted in the serving cell and in the target cells. The non-F1 terminating donor-CU will be the F1 terminating donor-CU for the IAB node (e.g. source F1 donor-CU 703) if the MT has not been migrated from its F1 terminating donor-CU. The target cells may be neighbouring cells to the serving or source cell (i.e. the current serving cell). Once the IAB-MT 704 discovers at least one SSB that meets predefined criteria (for instance a received power that exceeds a predefined threshold), a measurement report may be generated and transmitted to provide radio link quality information for different cells in the vicinity of the IAB-node 701. The identity of each cell is included in the measurement report to allow the non-F1 donor-CU if the IAB-MT 704 has been migrated, or F1 terminating donor-CU 703 if the IAB-MT 704 has not been migrated, to identify the target donor CU associated with the cell. Indeed, the identification of a donor-CU can be deduced from the Physical Cell identity (PCI) broadcasted in each cell managed by this donor-CU in a synchronization signal, and/or from the New Radio Cell Group Identifier (NCGI) also broadcasted in each cell managed by this donor-CU in a System Information Block (SIB) message. The PCI and/or the NCGI may be reported by the IAB-node 701 in the measurement report.

Based on the received measurement reports, the non-F1 donor-CU 709 if the IAB-MT 704 has been migrated, or F1 terminating donor-CU 703 if the IAB-MT 704 has not been migrated, may detect that the IAB-node 701 receives radio signals in a target cell of a target parent IAB-node with a better quality than in the source serving cell. The non-F1 donor-CU 709 if the IAB-MT 704 has been migrated, or F1 terminating donor-CU 703 if the IAB-MT 704 has not been migrated, may decide to apply a procedure to perform the IAB-MT 704 migration toward a target parent IAB node that belongs either to the same IAB topology (intra-CU topology adaptation), or to another IAB topology (inter-CU topology adaptation). In any case, the source F1 donor-CU 703 will be informed about this MT migration by the non-F1 donor-CU 709 if the IAB-MT 704 has been migrated or the source F1 donor-CU 703 will be informed since it made the decision to perform MT migration directly from the measurement reports received from the IAB-node 701 if the IAB-MT 704 has not been migrated, and this information may be used by the source F1 donor-CU 703 to trigger a DU migration of the IAB-node 701. In another example, the non-F1 donor-CU 709 may relay the information in the measurement reports received from the IAB-node 701 to the source F1 donor-CU 703. Thus, the source F1 donor-CU 703 may base its decision for DU migration of the IAB-node 701 directly from these measurement reports relayed by the non-F1 donor-CU 709.

Thus, the source F1 donor-CU 703 determines the DU of the IAB node is to be migrated from the IAB topology (also referred to as the source IAB topology) of the source F1 donor-CU 703 to another IAB topology (also referred to as the target IAB topology) of a target IAB donor CU. The determination may be based on determining that a migration of a MT of the IAB node toward a new parent IAB node has been completed. Another example of a triggering event for determining the DU of the IAB node is to be migrated may include the decision for DU migration may be based on the detection of a MT migration from a one IAB topology (e.g. first IAB topology) towards another IAB topology (e.g. second IAB topology), and on a known (predefined) trajectory of the IAB-node that indicates to the source F1 donor-CU that the MT will be migrated later to a yet another IAB topology (e.g. third IAB topology). In this case, to avoid signaling messages for DU migration/UEs handover toward the another IAB topology (e.g. second IAB topology), the DU is directly migrated toward the yet another IAB topology (e.g. third IAB topology). Another example of a triggering event for determining the DU of the IAB node is to be migrated may include the processing load level being detected above a predefined threshold in the source F1 donor-CU. Then DU migration is triggered and the choice of target F1 donor-CU is based on the processing load of other donor-CUs connected to the source F1 donor-CU.

Upon the decision of or determination by the source F1 donor-CU 703 to perform the DU migration of the IAB-node 701 toward another IAB topology managed by another donor-CU which becomes the target F1 donor-CU 707, the first step 720 corresponds to sending a request to the IAB node 701 to establish a new F1 connection between the target F1 donor-CU 707 and the mobile IAB node 701. This may require activation of the second logical IAB-DU2 706 in the mobile IAB node 701 and thus the first step 720 may include the activation of the second logical DU IAB-DU2 706 in the mobile IAB node 701. This operation is performed using, for example, the procedures described with reference to the FIGS. 10a and 10b. In particular, the message sent by the source F1 donor-CU 703 to the IAB-node 701 for the activation of the IAB-DU2 706 (e.g. 1003 in FIG. 10a) may include identification information for identifying the target donor CU, such as the TNL address (i.e. IP address) of the target F1 donor-CU 707, so that a new F1 connection or F1 association (e.g. a F1AP interface connection) may be set up with the target donor CU 707 (between the IAB-DU2 706 and the target donor CU 707). If the address of the target F1 donor-CU is not included in the request for activation, then by default and in the case where the IAB-MT 704 has been migrated to a non-F1 donor-CU 709, the non-F1 Donor-CU 709 is considered as the target F1 donor-CU. In this case, the IAB-node 701 has already been informed of the identity (e.g. the TNL address/IP address) of the target F1 donor-CU when the IAB-MT 704 was migrated to the non-F1 Donor-CU 709. In other words, the source F1 donor-CU 703 may send identification information for identifying the target F1 donor-CU 707 if the IAB-MT 704 has been migrated to a non-F1 donor-CU 709 different from (i.e. not the same as) the target F1 donor-CU 707. Alternatively, the source F1 donor-CU 703 may send identification information for identifying the non-F1 donor-CU 709 as the target IAB donor CU.

After determining the DU of the IAB node 701 is to be migrated and once the IAB-DU2 706 has been activated, then, the IAB-DU2 706 may send a F1 setup request message (e.g. 1013 in FIG. 10b) to the target F1 donor-CU 707 for requesting set up of the F1 connection between the IAB-node 701 and the target F1 donor-CU 707. This message may include identification information for identifying the source IAB donor CU, such as the TNL address (i.e. the IP address) and/or the identifier (i.e. Global NG-RAN Node ID as specified in TS 38.423 V17.2.0 section 9.2.2.3) of the source F1 donor-CU 703 of the IAB-node 701. The destination address of the F1 setup request message is the target F1 donor-CU 707, and when this IP packet is received by the donor-DU in the F1 path for the IAB-node 701, it can be routed in the wired backhaul (508 in the FIG. 5) up to the target F1 donor-CU 707. For instance, in an example where the IAB-node 701 is the IAB-node 570 of FIG. 5 which is connected to IAB-node 550 via backhaul link 5050 and where the MT (MT 571 which corresponds to IAB-MT 704 in FIG. 7) of the IAB-node 570 has been migrated to the non-F1 donor CU 502 and the IAB donor CU 501 is the source F1 donor CU, the F1 path between the FI donor CU 501 to the IAB-node 570 uses the donor-DU 506. In the case where the IAB donor CU 503 has been identified (by F1 donor CU 501) as the target F1 donor CU (e.g. target F1 donor-CU 707), the F1 setup request message for the target F1 donor-CU (for instance donor-CU 503) is sent through the IAB-nodes 550, 540 and then to the donor-DU 506 from where it can be routed in the wired backhaul (508 in the FIG. 5) up to the target F1 donor-CU 503. In the F1 setup response (e.g. 1014 in FIG. 10b), the target F1 donor-CU 707 (e.g. donor-CU 503 in the example described above with reference to FIG. 5) may request the IAB-DU2 706 to activate new cell(s) with associated identifiers (PCI, NCGI). Usually the DU activates/deactivates cell(s) under the control of the donor-CU which is controlling the DU. See, for example, TS 38.473 section 8.2.3.2.

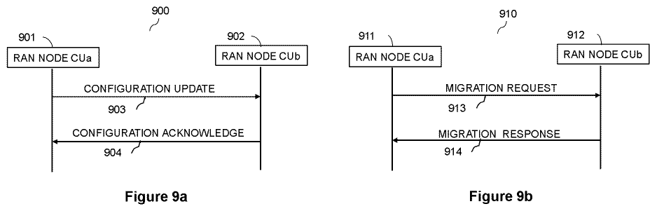

After the procedure described with reference to FIG. 10b, and using, for example, the procedure described with reference FIG. 9a, the target F1 donor-CU 707 (e.g. in the configuration update message 903) may inform the source F1 donor-CU 705 about the activation of new cell(s) from the IAB-DU2 706 of the IAB-node 701.

The next step 730 consists in the handover of UEs (e.g. UE 708 in FIG. 7) served by the IAB node 701, from the cell(s) of the first logical DU IAB-DU1 705 to the cell(s) of the second logical DU IAB-DU2 706. This procedure may be the standardized procedure described in TS 38.300 section 9.2.3.2 (handover), or the standardized procedure described in TS 38.300 section 9.2.3.4 (conditional handover). In an example, to trigger the handover of the UE 708, the source F1 donor-CU 703 sends a HANDOVER REQUEST message to the target F1 donor-CU 707 including the necessary information related to the UE 708 to hand over (e.g. identification information identifying the UE, UE context information, such as the security context (e.g. security parameters such as security key, UE security capabilities), measurement configuration, radio configuration (e.g. UE radio capability), information about bearers, etc.). TS 38.423, section 9.1.1.1 provides details as to the content of a HANDOVER REQUEST message. After an admission control step in which the target F1 donor-CU 707 determines whether the donor-CU can accept the handover of the UE 708, when the target F1 donor-CU 707 accepts the request, the target F1 donor-CU 707 sends a handover acknowledgement message to the source F1 donor-CU 705, including configuration information for the UE 708 for the handover. The configuration may include radio configuration information indicating the radio configuration to be used by the UE 708 to connect to the second logical DU IAB-DU2 706 of the IAB node 701 in an identified target cell of the second logical DU IAB-DU2 706 (e.g. the radio configuration may include frequency, radio bearer configuration, etc.). The handover acknowledgement may include an identifier for each of the one or more new cells (e.g. the target cell(s)) that have been activated at the second logical DU IAB-DU2 706. Then, the source F1 donor-CU 705 sends this configuration information to the UE 708 via the IAB node 701 in a RRC Reconfiguration message, including the identifier of the target cell of IAB-DU2 706 to which the UE 708 is to connect. The RRC Reconfiguration message (specified in TS 38.331) is embedded in a F1 message DL RRC MESSAGE TRANSFER (specified in TS 38.473), sent to the IAB-DU1 705 and relayed by the IAB-DU1 705 to the UE 708. Upon reception of this configuration information, the UE 708 performs a random-access procedure in the indicated target cell of IAB-DU2 706 to obtain uplink resources, and then to transmit a RRC Reconfiguration Complete message to the target F1 donor-CU 707. The RRC Reconfiguration Complete message (specified in TS 38.331) is sent to the IAB-DU2 706, and then embedded in a F1 message UL RRC MESSAGE TRANSFER (specified in TS 38.473), sent to the target F1 donor-CU 707. The source F1 donor-CU 705 may be informed about the completion of the UE 708 handover through the HANDOVER SUCCESS message (specified in TS 38.423) received from the target F1 donor-CU 707.

Once the handover of all UEs served by the IAB-DU1 705 of the IAB-node 701 is completed, the source F1 donor-CU 703 may deactivate the logical DU IAB-DU1 705 of the mobile IAB-node 701 through the procedure described with reference to FIG. 10c. This is represented generally by the procedure 735 in FIG. 7.

Also, the source F1 donor-CU 705 may release the traffic (user traffic, control traffic) related to the UEs that were served by the IAB-node 701 through the IAB-DU1 705 and the source F1 donor-CU 705. If the traffic was offloaded in an IAB topology controlled by the non-F1 donor-CU 709 (e.g. when the MT of the IAB-node 701 is migrated to the non-F1 donor-CU 709), the source F1 donor-CU 705 may apply the IAB transport migration management procedure specified in TS 38.423 V17.2.0 section 8.5.2 to request the traffic release to the non-F1 donor-CU 709. This is represented generally by the procedure 735 in FIG. 7.

Finally, the target F1 donor-CU 707 has to setup the data path(s) to/from the migrated IAB-node 701, either in its own topology if there is a backhaul path to reach the IAB-node 701 in the IAB topology controlled by the target F1 donor-CU 707 (i.e. the target F1 donor-CU 707 is a non-F1 terminating donor-CU for the IAB-node 701 as the IAB-MT 704 has previously been migrated to the target F1 donor-CU 707), or through the IAB topology of the non-F1 donor-CU 709 of the IAB-node 701 if there is no backhaul path to reach the IAB-node 701 in the IAB topology controlled by the target F1 donor-CU 707 (i.e. IAB-MT 704 and IAB-DU2 706 are connected to different donor-CUs). In this latter case, the target F1 donor-CU 707 may trigger the transport migration and path switch procedure 731 including the request of traffic migration to the non-F1 donor-CU 709 of the IAB-node 701 (for instance through the IAB transport migration management procedure specified in TS 38.423 V17.2.0 section 8.5.2), and the path switch procedure toward the core network 702. As an example of this latter case with reference to FIG. 5, the IAB-node 701 is the IAB-node 570 of FIG. 5 connected to IAB-node 550 via backhaul link 5050 and where the MT (MT 571 which corresponds to IAB-MT 704 in FIG. 7) of the IAB-node 570 has been migrated to the non-F1 donor CU 502 and the IAB donor CU 501 is the F1 donor CU. When the DU (DU 572 which corresponds to IAB-DU2 706 in FIG. 7) of the IAB-node 570 has been migrated to the target donor CU 503, and so has a F1 connection to the F1 donor CU 503, but the MT 571 remains connected through its RRC connection to the non-F1 donor-CU 502, (its RRC connection), the data path(s) or backhaul path(s) to/from the IAB-node 570 is set up in the IAB topology 5002 controlled by the IAB donor CU 502 (i.e. a backhaul path to the IAB node 570 through the IAB donor DU 506, IAB nodes 540 and 550) by performing the traffic migration management procedure. Also, the target donor-CU 503 may perform a path switch procedure toward the core network 702 to request the delivery of the user data related to the UE 708/580. For example, target donor-CU 503 may perform the path switch handshake procedure described in 3GPP TS 38.413 v 17.2.0 section 8.4.4.

After the handover of UE 708 and the setup of the new data paths has been performed (731), the user data in the downstream direction are transmitted by the core network 702 to the target F1 donor-CU 707 through the bearer 740, then they are transmitted to the logical DU IAB-DU2 706 of the IAB-node 701 through the backhaul bearer 741, and finally to the UE 708 through the data radio bearer 742. The backhaul bearer 741 may be established in the IAB topology controlled by the target F1 donor-CU 707, or in the IAB topology controlled by the non-F1 donor-CU 709 of the IAB-node 707 (e.g. depending on whether the IAB-MT 704 and IAB-DU2 706 of IAB node 701 are connected to different donor-CUs). User data in the upstream direction (not represented in the figure) are transmitted through similar bearers in the opposite direction.

In case the target F1 donor-CU 707 is not able to accommodate the IAB-node DU (IAB-DU2 706) and the traffic related to the served UEs like UE 708 (because of some lack of processing resources, or some lack of radio/network resources), the target F1 donor-CU 707 should be allowed to reject or to revoke the DU migration (and thus the subsequent handover of UEs). The target F1 donor-CU may also be allowed to partially accept the DU migration, for instance by accepting a limited amount of traffic or a limited number of served UEs.

Examples of methods, in accordance with one or more embodiments of the present invention, which enable a target donor-CU to partially accept, to reject or to revoke a request for DU migration of an IAB-node will now be described. Although the following methods/apparatus' will be described primarily with respect to a mobile IAB node, it will be appreciated that it is not intended that the invention is limited to mobile IAB nodes. The methods in accordance with one or more embodiments of the present invention may apply to stationary IAB nodes e.g. that are at the edge of one IAB topology and in the proximity of or in the vicinity of one or more IAB nodes in a neighbouring IAB topology.

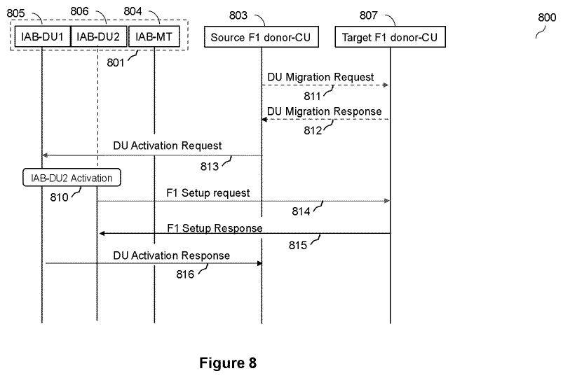

In general terms, methods (and apparatus configured to perform such methods) for use in managing DU migration of a DU of an IAB node, from a source IAB topology managed by a source IAB donor CU to a target IAB topology managed by a target IAB donor CU in accordance with one or more embodiments of the invention comprise receiving, at the target IAB donor CU, a message indicating a DU migration of the DU of the IAB node from the source IAB donor CU to the target IAB donor CU is requested. The message sent to the target IAB donor CU may be sent by the source IAB donor CU (e.g. the migration request 811, 913 as discussed below with reference to FIGS. 8 and 9b) or the message may be sent by the IAB node (e.g. the F1 setup request 814, 1013 as discussed below with reference to FIGS. 8 and 10b). The message is sent following a determination that the IAB node is to be migrated to the target IAB donor CU. For example, the source IAB donor CU may determine that there is a need (e.g. a triggering event for the migration has occurred) to migrate the DU of the IAB node to another IAB donor CU and may then decide to which IAB donor CU the DU migration shall be performed. Examples of reasons and triggering events for determining the DU of the IAB node is to be migrated have been discussed above with respect to FIG. 7. The message sent to the target IAB donor CU may include context information relating to the context of the DU migration to help the target IAB donor CU decide whether to accept or reject the request for DU migration of the IAB node or in some cases to partially accept the DU migration of the IAB node.

In response to the received message (or after receiving the message), the target IAB donor CU determines whether to (fully) accept or partially accept or reject the DU migration of the IAB node. The decision may be based for example on whether the target IAB donor CU is able to accommodate the IAB node (e.g. all of the traffic associated with the IAB node) and the traffic related to all of the UEs served by the IAB node (e.g. based on the available resources at the target IAB donor CU, such as processing resources, and/or radio/network resources). The target IAB donor CU sends a response indicating the target IAB donor has determined to accept or partially accept or reject the DU migration of the IAB node. As an optimization, the target IAB donor-CU may partially accept the DU migration by accepting a subset or some of the traffic related to the UEs served by the IAB node (e.g. by accepting at least one of one or more traffic profiles associated with the IAB node), and/or by accepting a subset or some of the UEs served by the IAB node (e.g. by accepting at least one of the UEs served by the IAB node). The decision to partially accept may be based on the comparison of the available resources, such as the processing resources and/or network resources at the target IAB donor (and at the controlled IAB topology (i.e. the topology controlled by the target IAB donor), with the resources, such as the processing/network resources, required by the traffic profile(s) to be migrated, and/or on the comparison of the number of additional UEs that can be connected to the target IAB donor-CU with the number of UEs served by the IAB-node. If the available processing/radio resources are not sufficient to accommodate the whole traffic (e.g. including all of the traffic associated with the traffic profile(s) to be migrated) and/or all the served UEs, the target IAB donor-CU may select a subset or some of the traffic profile(s) and/or a limited number or a subset or some of the served UEs to support. The criterion for selection may be related to QoS parameters indicating some priority among traffic profiles/UEs, and the target IAB donor-CU may select to accept the traffic profiles/UEs with the highest priority. For a served UE, a criterion may be the onboard status of the UE with respect to the IAB-node: i.e. whether the UE is physically inside a moving vehicle equipped with the IAB-node or otherwise surrounding and moving with the IAB-node. Indeed, if the handover of an onboard UE toward the target IAB donor-CU for DU migration is rejected, then this UE will have to be handed over to another cell (controlled by another CU) and it will lose the benefit of the mobile cell served by the IAB node. An advantage to partially accept a DU migration is to give the source donor-CU a possibility to maintain some UEs with highest priority connected to the mobile cell of the IAB node, especially when there is no alternative choice for a target IAB donor-CU other than the target IAB donor-CU.

In response to or after determining to reject (or partially accept) the DU migration, the target IAB donor CU sends a response (e.g. a message) indicating the target IAB donor CU has rejected (or partially accepted) the request for DU migration to the target IAB donor CU. The message sent by the target IAB donor CU may be sent to the source IAB donor CU (e.g. the migration response 812, 914 as discussed below with reference to FIGS. 8 and 9b or a configuration update message 903 sent based on F1 setup as discussed below with reference to FIG. 9a) or the message may be sent to the IAB node (e.g. the F1 setup response 815, 1014 as discussed below with reference to FIGS. 8 and 10b). In the case the DU migration is rejected or revoked by the target IAB donor CU, the migration process is not executed (e.g. the source IAB donor CU does not send an DU activation request 813) or if it has already been initiated, execution of the migration process is cancelled. In case of partial acceptance, the response may include the identification of the part of the traffic that is accepted (e.g. the index(es) of the accepted traffic profile(s) that have been accepted), and/or the number of UEs that are accepted.

In response to or after determining to (fully or partially) accept the DU migration, the target IAB donor CU sends a message indicating the target IAB donor CU has (fully or partially) accepted the DU migration and in response, the source IAB donor CU may initiate the migration process which is then executed or continues to perform the migration process (e.g. the steps of the migration process described above with reference to FIG. 7 are performed). In case of partial acceptance, the source IAB donor CU may not execute the migration process, and in such a case, the source IAB donor CU may send a new request later or select another target IAB donor-CU. The message sent by the target IAB donor CU may be sent to the source IAB donor CU (e.g. the migration response 812, 914 as discussed below with reference to FIGS. 8 and 9b or a configuration update message 903 sent based on F1 setup as discussed below with reference to FIG. 9a) or the message may be sent to the IAB node (e.g. the F1 setup response 815, 1014 as discussed below with reference to FIGS. 8 and 10b).

After determining to (fully or partially) accept the DU migration, the target IAB donor CU may determine to revoke the DU migration of the IAB node to the target IAB donor CU and may send a revocation response indicating the target IAB donor CU has determined to revoke the DU migration of the IAB node to the target IAB donor CU. For example, in case that after acceptance or partial acceptance of the request of the DU migration, and during the execution of the process for DU migration together with the served UEs or even after the DU migration process has been completed or terminated, the target IAB donor CU detects that it is no longer able to accommodate the migrated IAB node and the served UEs, then the target IAB donor CU can revoke the DU migration. The revocation response indicating the target IAB donor CU has determined to revoke the DU migration may be sent to the source IAB donor CU. For example, the procedure described with reference to the FIG. 9b may be used to signal the revocation to the source IAB donor CU. The revocation response indicating the target IAB donor CU has determined to revoke the DU migration may be sent to the IAB node. For example, the target IAB donor-CU may also take the opportunity of the F1 setup procedure described with reference to the FIG. 10b to revoke the DU migration previously accepted. At reception of the message indicating the revocation, the DU migration process is stopped. If some UEs were already handed over to the target IAB donor CU, these UEs are handed back to the source IAB donor-CU. If the second logical DU of the IAB-node was already activated, it is removed by the target IAB donor CU using the procedure described with reference to FIG. 10c.

The message sent by the target IAB donor CU to reject or to revoke a DU migration includes a cause information for indicating the cause of the rejection or revocation of the request for DU migration to the target donor CU. The message sent by the target IAB donor CU to partially accept a DU migration may include a cause information for indicating the cause of the partial acceptance of the request for DU migration to the target donor CU (e.g. overload). It may also include an identification of the part of the traffic that is accepted (e.g. the index(es) of the accepted traffic profile(s)) and/or the number of UEs that are accepted.

After partial acceptance, rejection or revocation, the source IAB donor-CU may decide to postpone the DU migration and to make a new attempt later, or it may decide to select another target donor-CU.

Thus, the method/apparatus in accordance with one or more embodiments of the present invention enables the target IAB donor CU to reject or to revoke the DU migration (and thus, the subsequent handover of UEs served by the IAB node) in the case the target IAB donor CU is not able to accommodate a part of the traffic or the whole traffic related to the served UEs (because of some lack of processing resources, or some lack of radio/network resources). In case of partial acceptance, the source IAB donor CU performs the handover toward the target IAB donor CU (for the DU migration) for the UEs for which the traffic has been accepted and/or for a number of UEs accepted by the target IAB donor CU. The other UEs are handed over toward a different CU (which may be any base station, not only an IAB donor CU).

FIG. 8 is a simplified diagram illustrating example message flows, according to one or more embodiments of the invention, to allow a target F1 terminating donor-CU to accept, partially accept, or reject the DU migration of an IAB-node. For example, the message flows shown in FIG. 8 enable a target IAB donor CU (e.g. target F1 terminating donor CU) to determine whether to (fully or partially) accept or reject DU migration of an IAB-node to the target IAB donor CU and in response to or after determining to fully or partially accept or to reject the DU migration, to inform the source IAB donor CU (e.g. source F1 terminating donor-CU) that the target IAB donor CU has fully or partially accepted or rejected the request for DU migration.

This FIG. 8 shows a source F1 donor-CU 803 like the donor-CU 501, a target F1 donor-CU 807 like the donor-CU 503, and an IAB-node 801 that may be a mobile IAB-node like the IAB-node 570 composed of a MT part or unit IAB-MT 804, a DU part or unit IAB-DU1 805 (e.g. source or first logical DU entity or DU), and a DU part or unit IAB-DU2 806 (e.g. target or second logical DU entity or DU). Each of the first 805 and second 806 logical DU entities serve one or more cells. IAB-DU1 805 and IAB-DU2 806 are two logical DU entities that share the same hardware for the BAP, RLC, and MAC layers. In one example, they share the same physical layer (i.e. the same hardware resources), while in another example they rely on separated physical layers.

At the beginning of the flow, the IAB-node 801 belongs to the source IAB topology controlled by the source F1 donor-CU 803. According to one embodiment of the invention, upon the decision of or determination by the source F1 donor-CU 803 to perform the DU migration of the IAB-node 801 toward the IAB topology managed by the target F1 donor-CU 807, the first step corresponds to sending a request for requesting DU migration of the DU of the IAB-node 801 from the source F1 donor-CU 803 to the target F1 donor-CU 807. The request may be sent as a DU migration request message 811 by the source F1 donor-CU 803 to the target F1 donor-CU 807. The message 811 is used to inform the target F1 donor-CU 807 that it has been selected by the source F1 donor-CU 803 to be the new F1 terminating donor-CU for the IAB-node 801. The message 811 may be followed by a response, such as the DU migration response message 812, sent by the target F1 donor-CU 807 to the source F1 donor-CU 803 either to (fully or partially) accept the DU migration or to reject the DU migration. The decision to (fully or partially) accept or to reject may be based on the current load of processing resources of the target F1 donor-CU 807, or on the current load of network resources (wired backhaul and/or wireless backhaul) in the IAB topology managed by the target F1 donor-CU 807. To assist the decision by the target F1 donor-CU 807, the request, such as the DU migration request message 811, may include context information relating to associated with the context of the DU migration to the target F1 donor-CU 807. The context information may include part or all of the following information that may be referred as the context of the DU migration:
identification information for identifying the IAB node. The identification information may include the identifier of IAB-node 801 as known by the source F1 donor-CU 803, either with the information element F1-Terminating IAB-donor UE XnAP ID identifying the MT 804 of the IAB-node 801, or with the information element gNB-DU ID identifying the first logical DU IAB-DU1 805 of the IAB-node 801. The identification information may, additionally or alternatively, include the identifier of the IAB-node 801 as known by the IAB donor CU serving the MT 804 of the IAB node 801, if the MT 804 has been migrated to a non-F1 donor-CU (or RRC terminating donor-CU) and if this non-F1 donor-CU is different from the target F1 donor-CU 807, with the information element non-F1-Terminating IAB-donor UE XnAP ID identifying the MT 804 of the IAB-node 801,
identification information for identifying the IAB donor CU serving the MT 804 of the IAB node 801, if the MT 804 has been migrated to a non-F1 donor-CU and if this non-F1 donor-CU is different from the target F1 donor-CU 807, with for instance the TNL address (i.e. the IP address) and/or the identifier (i.e. Global NG-RAN Node ID as specified in TS 38.423 V17.2.0 section 9.2.2.3) of the non-F1 donor-CU of the IAB-node 801,
an indication related to the priority to consider for the DU migration request. For example, priority information for indicating a level of priority for the request for DU migration. It may be a value within a predefined range (e.g. from 1 to 5), where a low value indicates that the DU migration is not critical for the source F1 donor-CU 803, while a high value indicates of the DU migration is critical for the source F1 donor-CU 803, for instance because of some load issue associated to the processing or radio/network resources in the source F1 donor-CU's IAB topology,
an indication related to the profile of the user traffic associated to the IAB-node 801 (e.g. traffic profile information for indicating a profile of user traffic associated with the IAB node), including QoS (Quality of Service) parameters, as defined in TS 38.423 V17.2.0 section 9.2.2.81. Each traffic profile may be identified by a traffic index,
an indication related to the throughput of the user traffic associated to the IAB-node 801 (e.g. traffic throughput information for indicating the throughput of user traffic associated with the IAB node), both in upstream (from the IAB-node) and downstream direction (to the IAB-node),
the number of UEs, like UE 580, served by the IAB-node 801 that would be handed over to the target F1 donor-CU 807 together with the DU migration of the IAB-node 801. In addition, the number of onboard UEs may be indicated (i.e. UEs physically inside the vehicle equipped with the IAB-node or otherwise surrounding and moving with the IAB-node).

F1-Terminating IAB-donor UE XnAP ID and non-F1-Terminating IAB-donor UE XnAP ID correspond to a NG-RAN node UE XnAP ID as specified in TS 38.423 section 9.2.3.16.

In case of partial acceptance or rejection of the DU migration request, the target F1 donor-CU 807 may include the cause of the partial acceptance or rejection in the DU migration response message 812. The cause may be, for instance, a lack of processing resources, or a lack of radio/network resources. Each possible cause may be associated to a predefined value, as for instance specified in TS 38.423 V17.2.0 section 9.2.3.2. In case of partial acceptance, the response may include the index of the traffic profiles that are accepted, and/or the number of UEs that are accepted.

The messages 811 and 812 may correspond to the procedure described with reference to FIG. 9b where message 811 corresponds to message 913 and message 812 corresponds to message 914 at the FIG. 9b. They are exchanged between the source F1 donor-CU 803 and the target F1 donor-CU 807 before the migration process or procedure describe with reference to FIG. 7 is executed, which is only executed if the target F1 donor-CU 807 has (fully or partially) accepted the DU migration request.

As another example of method to allow a target F1 terminating donor-CU to partial accept or to reject the DU migration of an IAB-node, the source F1 donor-CU 803 may trigger the procedure described with the reference 720 at the FIG. 7. Upon the decision of or determination by the source F1 donor-CU 803 to perform the DU migration of the IAB-node 801 toward the IAB topology managed by the target F1 donor-CU 807, the first step corresponds to sending a request for establishing a F1 connection between the target F1 donor-CU 807 and the mobile IAB-node 801 for informing the target F1 donor-CU 807 the F1 connection to be established relates to a request for DU migration of the IAB-node 801 to the target F1 donor-CU 807. The request may be sent as a DU activation request message 813 to the IAB node 801, to establish a new F1 connection between the target F1 donor-CU 807 and the mobile IAB node 801, through the second logical DU IAB-DU2 804. The activation of the second logical IAB-DU2 806 in the mobile IAB node 801 is performed with the operation 810. The message 813 sent by the source F1 donor-CU 803 to the IAB-node 801 for the activation of the IAB-DU2 806 is sent to the first logical DU IAB-DU1 805 as the source F1 donor-CU 803 has a F1 connection with this first logical DU of the IAB-node 801. The DU activation request message 813 may be a configuration request message 1003 as shown in FIG. 10a. This message 813 includes a request for establishing a F1 connection and for informing the target donor CU 807 of the identity of the IAB donor CU serving the MT 804 of the IAB node 801. The request may indicate (explicitly or implicitly) to the IAB node 801 that the IAB node is to inform the target F1 donor CU 807 the F1 connection to be established relates to a request for DU migration of the IAB-node 801 to the target F1 donor-CU 807 and may also inform the target F1 donor CU 807 of the context of the DU migration as described above. For example, the DU activation request message 813 may include the context information as described above with respect to message 811 and the message 813 may indicate (explicitly or implicitly) that the IAB node 801 is to provide at least some of the context information in the received DU activation request message 813 to the target F1 donor CU 807.

After activation of the second logical DU IAB-DU2 806, the information contained in the message 813 may be transmitted from the first logical DU IAB-DU1 805 to the second logical DU IAB-DU2 806.

In particular, the message 813 may include identification information for identifying the target F1 donor CU 807, such as the TNL address (i.e. IP address) of the target F1 donor-CU 807, so that a new F1 connection or F1 association (e.g. a F1AP interface connection) may be set up with the target donor CU 807 (between the IAB-DU2 806 and the target donor CU 807). This message 813 may also include a request to inform the identified target F1 donor-CU 807 of the context of the DU migration as described above. For example,

Once activated, the IAB-DU2 806 may send a F1 setup request message 814 to the target F1 donor-CU 807 for requesting the setup of the F1 connection between the IAB-node 801 and the target F1 donor-CU 807 and for indicating the F1 connection to be established relates to a request for DU migration of the IAB node 801 to the target F1 donor-CU 807. This message 814, also described with the reference 1013 at the FIG. 10b, may include the information that the F1 setup request is related to the DU migration of the IAB-node 801. Thus, the message 814 may include identification information for identifying the source F1 donor-CU 803, such as the TNL address (i.e. the IP address) and/or the identifier (i.e. Global NG-RAN Node ID as specified in TS 38.423 V17.2.0 section 9.2.2.3) of the source F1 donor-CU 803 of the IAB-node 801. This message 814 may also include information related to the context of the DU migration as described above. For example, message 814 may include the context information described above with reference to message 811. Finally, the message 814 may include the identifier gNB-DU ID of the second logical DU IAB-DU2 806 of the IAB-node 801. As specified in TS 38.473 section 9.3.1.19, the gNB-DU ID uniquely identifies the gNB-DU at least within a gNB-CU. Thus, a logical DU of an IAB-node is assigned a unique ID by configuration. The unique ID may be provided to the F1 IAB donor-CU terminating the F1 connection with the logical DU at F1 setup procedure (described in the FIG. 10b).

In the F1 setup response 815 (and also described with the reference 1014 in FIG. 10b), the target F1 donor-CU 807 may accept or reject the F1 setup request. As the F1 setup request is related to the DU migration of an IAB-node, the F1 setup request may be accepted by the target F1 donor-CU 807 if the DU migration of the IAB-node is partially or fully accepted, and the F1 setup request may be rejected by the target F1 donor-CU 807 if the DU migration of the IAB-node is not accepted or rejected. The decision by the target F1 donor-CU 807 may be based on the information related to the context of the DU migration (if context information is included in the message 814). In case of (full or partial) acceptance, the target F1 donor-CU 807 may request the IAB-DU2 806 to activate new cell(s) with associated identifiers (PCI, NCGI). Usually the DU activates/deactivates cell(s) under the control of the donor-CU which is controlling the DU. See, for example, TS 38.473 section 8.2.3.2. In case of rejection or partial acceptance, the target F1 donor-CU 807 may indicate (e.g. via cause information included in the message 815) the cause of the rejection/partial acceptance as described above with respect to the message 812. In case of partial acceptance, the response may identify the part of the traffic that is accepted (e.g. the index(es) of the accepted traffic profile(s)), and/or the number of UEs that are accepted.

After reception of the F1 setup response message 815, the IAB-DU2 806 may inform the IAB-DU1 805 about the result of the activation procedure (i.e. activation of IAB-DU2 806 and activation of new cell(s)). Then, the IAB-DU1 805 may relay this information to the source F1 donor-CU 803 through a response, such as the message DU activation response 816, which indicates whether the target F1 donor-CU 807 has accepted or rejected the request for establishing a F1 connection between the target F1 donor-CU 807 and the IAB-node 801 and hence has (partially or fully) accepted or rejected the request for DU migration of the IAB-node 801. In case of successful activation (i.e. in case of the target F1 donor-CU 807 has (partially or fully) accepted the DU migration of the IAB-node 801), this message 816 may include the gNB-DU ID of the second logical DU IAB-DU2 806 of the IAB-node 801. In case of partial acceptance, the message 816 may indicate the cause of this partial acceptance. The message 816 is further described with the reference 1004 in FIG. 10a. In the case when the target F1 donor-CU 807 has rejected the request for DU migration of the IAB-node 801, the response 816 indicates the target IAB donor CU has rejected the request for establishing a F1 connection between the target F1 donor-CU 807 and the IAB-node 801 and hence has rejected the request for DU migration of the IAB-node 801. The response 816 may include cause information for indicating the cause of the rejection of the request for DU migration to the target donor CU as described above with respect to the message 812.

As a variant of the method above, when the target F1 donor-CU 807 has rejected or revoked the DU migration of the IAB-node 801 and thus rejected the F1 setup request 814, the IAB-node 801 may not send the message 816 or may send the message 816 without the cause of unsuccessful DU activation. In this case, it will be the target F1 donor-CU 807 that will directly inform the source F1 donor-CU 803 with, for instance, the procedure described at the FIG. 9a. For example, in such a case, the target F1 donor-CU 807 may send a response (such as message 903 described with reference to FIG. 9a) to the source F1 donor-CU 803, which response indicates the target F1 donor-CU 807 has rejected/revoked the request for DU migration of the IAB-node 801 to the target F1 donor-CU 807. Such a response may also include cause information for indicating the cause of the rejection/revocation of the request for DU migration to the target donor CU as described above with respect to the message 812.

FIG. 9a is a schematic and simplified diagram 900 illustrating an example message flow of a procedure in accordance with embodiments of the present invention, used by a RAN Node CU to report configuration information to another RAN Node CU according to an example.

This figure shows two RAN nodes, RAN node CUa 901 and RAN node CUb 902, that may be two IAB-Donor-CUs, like two of IAB-donor-CUs 501, 502, and 503 of FIG. 5. With respect to the example shown in FIG. 8, RAN node CUa 901 may be the target F1 donor-CU 807 and RAN node CUb 902 may be the source F1 donor-CU 803. RAN node may be IAB-node 801.

In particular, the message 903 may be sent by the RAN node CUa 901 to report the status of a F1 setup procedure related to the DU migration of a RAN node, for which the RAN node CUb 902 is the F1 terminating donor-CU that has previously triggered the F1 setup procedure following the decision to migrate the RAN node DU to the RAN node CUa 901. The RAN node DU may the DU of an IAB-node like the IAB-node 801.

In case of successful F1 setup operation, meaning that the RAN node CUa 901 has (fully or partially) accepted the DU migration of the RAN node, the message CONFIGURATION UPDATE 903 may be sent by the RAN node CUa 901 to the RAN node CUb 902 to inform the RAN node CUb 902 about the activation of new cell(s) in a logical DU of a RAN node DU like the IAB-DU2 806 of the IAB-node 801.

For example, the source F1 donor-CU 803 receives the CONFIGURATION UPDATE message 903 from the target F1 donor-CU 807 and the CONFIGURATION UPDATE message 903 includes identification information (e.g. PCI, NRGI) identifying one or more new cells that have been activated at a second logical DU entity (IAB-DU2 806) of the DU of the IAB node 801.

The messages 903 may also include at least one of:
the identifier of the migrated RAN node as known by the RAN node CUa 901, either with the information element FI-Terminating IAB-donor UE XnAP ID identifying the Mobile Termination (MT) of the migrated RAN node, or with the information element gNB-DU ID identifying the logical DU of the migrated RAN node having F1 connection with the RAN node CUa 901,
the identifier of the MT of the migrated RAN node as known by the RAN node CU terminating the RRC connection with the migrated RAN node, through the information element non-F1-Terminating IAB-donor UE XnAP ID,
the identifier gNB-DU ID of a logical DU of the migrated RAN node having a F1 connection with the RAN node CUb 902,
the cause information related to the cause of the partial acceptance in case of partial acceptance of the DU migration,
the index of the traffic profiles that are accepted, and/or the number of UEs that are accepted in case of partial acceptance.

In case of unsuccessful F1 setup operation, meaning that the RAN node CUa 901 has rejected or revoked the DU migration of the RAN node, the message CONFIGURATION UPDATE 903 may be sent by the RAN node CUa 901 to the RAN node CUb 902 to inform the RAN node CUb 902 about the rejection/revocation of the DU migration of the RAN node. In that case, the message 903 may include an information element (e.g. cause information) indicating the cause of the rejection/revocation, as described with reference to the message 812 in the FIG. 8.

The RAN node CUb 902 may answer with the message CONFIGURATION ACKNOWLEDGE 904 sent to the RAN node CUa 901.

According to one example, the FIG. 9a corresponds to the procedure NG-RAN node configuration update described in TS 38.423 V17.2.0 section 8.4.2, and the message 903 corresponds to the message NG-RAN NODE CONFIGURATION UPDATE described in TS 38.423 V17.2.0 section 9.1.3.4, amended with IEs listed above, while the message 904 corresponds to the message NG-RAN NODE CONFIGURATION UPDATE ACKNOWLEDGE described in TS 38.423 V17.2.0 section 9.1.3.5.

FIG. 9b is a simplified diagram 910 illustrating an example message flow, according to one or more embodiments of the invention, of a procedure used by a RAN node CU to manage the DU migration of a RAN node in coordination with another RAN node CU, including the signaling to partially accept, to reject or to revoke the DU migration.

This figure shows two RAN nodes, RAN node CUa 911 and RAN node CUb 912, that may be two IAB-Donor-CUs, like two of IAB-donor-CUs 501, 502, and 503 of FIG. 5.

The message MIGRATION REQUEST 913 is sent by the RAN node CUa 911 to the RAN node CUb 912 to request the DU migration of a RAN node that may be an IAB-node like the IAB-node 801. For example, with reference to FIG. 8, the source F1 donor-CU 803 may send a MIGRATION REQUEST 913 to the target F1 donor CU 807 to request the DU migration of the IAB-node 801. In other words, MIGRATION REQUEST 913 may correspond to message 811 described above with reference to FIG. 8.

The message 913 may also include context information relating to or associated with the context of the DU migration to the target F1 donor-CU 807. The context information may include a part or all of the following information that may be referred to the context of the DU migration:
identification information for identifying the RAN node. The identification information may include the identifier of the RAN node as known by the RAN node CUa 911, either with the information element F1-Terminating IAB-donor UE XnAP ID identifying the MT of the RAN node, or with the information element gNB-DU ID identifying a first logical DU of the RAN node. The identification information may, additionally or alternatively, include the identifier of the RAN node as known by the RAN node CU serving the MT of the RAN node, if the MT has been migrated to a non-F1 RAN node CU and if this non-F1 donor-CU is different from the RAN node CUb 912, with the information element non-F1-Terminating IAB-donor UE XnAP ID identifying the MT of the RAN node,
identification information for identifying the RAN node CU serving the MT of the RAN node, if the MT has been migrated to a non-F1 RAN node CU and if this non-F1 RAN node CU is different from the RAN node CUb 912, with for instance the TNL address (i.e. the IP address) and/or the identifier (i.e. Global NG-RAN Node ID as specified in TS 38.423 V17.2.0 section 9.2.2.3) of the non-F1 RAN node CU of the RAN node,
an indication related to the priority to consider for the DU migration request. For example, priority information for indicating a level of priority for the request for DU migration. It may be a value within a predefined range (e.g. from 1 to 5), where a low value indicates that the DU migration is not critical for the RAN node CUa 911, while a high value indicates of the DU migration is critical for the RAN node CUa 911, for instance because of some load issue associated to the processing or radio/network resources in the IAB topology controlled by the RAN node CUa 911,
an indication related to the profile of the user traffic associated to the RAN node (e.g. traffic profile information for indicating a profile of user traffic associated with the RAN node), including QoS (Quality of Service) parameters, as defined in TS 38.423 V17.2.0 section 9.2.2.81. Each traffic profile may be identified by a traffic index,
an indication related to the throughput of the user traffic associated to the RAN node (e.g. traffic throughput information for indicating the throughput of user traffic associated with the RAN node), both in upstream (from the RAN node) and downstream direction (to the RAN node),
the number of UEs that would be handed over to the RAN node CUb 912 together with the migration of the RAN node DU. In addition, the number of onboard UEs may be indicated (i.e. UEs physically inside the vehicle equipped with the IAB-node or otherwise surrounding and moving with the IAB-node).

F1-Terminating IAB-donor UE XnAP ID and non-F1-Terminating IAB-donor UE XnAP correspond to a NG-RAN node UE XnAP ID as specified in TS 38.423 section 9.2.3.16.

The RAN node CUb 912 answers with the message MIGRATION RESPONSE 914 to the RAN node CUa 911 to (fully or partially) accept or to reject the request.

The procedure described with the FIG. 9b may be used by the RAN node CUb 912 to revoke a DU migration previously accepted. For this purpose, the RAN node CUb 912 sends another message MIGRATION RESPONSE 914 to indicate the revocation to the RAN node CUa 911.

In case of partial acceptance, rejection or revocation, the message 914 may include an information element (e.g. cause information) indicating the cause of the partial acceptance, rejection or revocation, as described with reference to the message 812 in the FIG. 8. In case of partial acceptance, the response may include the index of the traffic profiles that are accepted, and/or the number of UEs that are accepted.

The FIG. 9b may correspond to the handover preparation procedure specified TS 38.423 V17.2.0 section 8.2.1, and amended with the information elements and the behaviour described above. The message 913 may correspond to the HANDOVER REQUEST message specified in TS 38.423 V17.2.0 section 9.1.1.1. In case of (full or partial) acceptation of the DU migration, the message 914 may correspond to the HANDOVER REQUEST ACKNOWLEDGE message specified in TS 38.423 V17.2.0 section 9.1.1.2, while in case of rejection or revocation of the DU migration, the message 914 may correspond to the HANDOVER PREPARATION FAILURE message specified in TS 38.423 V17.2.0 section 9.1.1.3.

FIG. 10a is a simplified diagram 1000 illustrating an example message flow, according to one or more embodiments of the invention, of a procedure to perform the activation of a logical DU in a RAN node, including the signaling to partially accept, reject or revoke by a RAN node CU the DU migration of the RAN node.

This figure shows:
a RAN node DU 1001 of a RAN node, that may be DU of an IAB-node like IAB-DU 572 of IAB node 570 of FIG. 5 (and IAB-DU1 805 of IAB node 801 of FIG. 8),
a RAN node CU 1002, that may be an IAB-Donor-CU like IAB-donor-CU 501 of FIG. 5 (and source F1 donor-CU 803 of FIG. 8).

The message CONFIGURATION REQUEST 1003 is sent by the RAN node CU 1002 to the RAN node DU 1001 either to request the activation of new cell(s) controlled by the RAN node DU 1001, or to request the activation of a logical DU, or to request the deactivation of cell(s) in the RAN node DU 1001. In case of a logical DU activation, the message 1003 may include the TNL address (i.e. IP address) of a target RAN node CU (e.g. the target F1 donor-CU 807 of FIG. 8) that will connect to the logical DU once activated. For example, CONFIGURATION REQUEST 1003 may be sent by the source IAB donor CU to the IAB node (e.g. the first logical DU entity 805 having a F1 connection with the source IAB donor CU) for requesting establishment of a F1 connection between a target IAB donor CU and the IAB node (e.g. CONFIGURATION REQUEST 1003 may correspond to request described above with reference to FIG. 8, which is a request for establishing a F1 connection between a target IAB donor CU and the IAB node for informing the target IAB donor CU the F1 connection to be established relates to a request for DU migration of the IAB node to the target IAB donor CU). The message 1003 may also include an information element (IE) indicating that the request is related to the DU migration of the RAN node. This IE may be limited to one bit: one value (i.e. “0” or “1”) of this one-bit IE means no specific action is requested and another value (i.e. “1” or “0”) means sending the context of the DU migration to the target RAN node CU (e.g. the target F1 donor-CU 807 of FIG. 8) that will connect to the logical DU once activated. This IE may be extended to include context information which may include a part or all of the following information that may be referred to as the context of the DU migration:
identification information for identifying the RAN node. The identification information may include the identifier of the RAN node as known by the RAN node CUa 1002, either with the information element F1-Terminating IAB-donor UE XnAP ID identifying the MT of the RAN node, or with the information element gNB-DU ID identifying the RAN node DU 1001. The identification information may include, additionally or alternatively, the identifier of the RAN node as known by the RAN node CU serving the MT of the RAN node, if the MT has been migrated to a non-F1 (or RRC) RAN node CU and if this non-F1 donor-CU (or RRC terminating donor-CU) is different from the RAN node CUb 1002, with the information element non-F1-Terminating IAB-donor UE XnAP ID identifying the MT of the RAN node,
identification information for identifying the RAN node CU serving the MT of the RAN node, if the MT has been migrated to a non-F1 RAN node CU and if this non-F1 RAN node CU is different from the RAN node CUb 1002, with for instance the TNL address (i.e. the IP address) and/or the identifier (i.e. Global NG-RAN Node ID as specified in TS 38.423 V17.2.0 section 9.2.2.3) of the non-F1 RAN node CU of the RAN node,
an indication related to the priority to consider for the DU migration request. For example, priority information for indicating a level of priority for the request for DU migration. It may be a value within a predefined range (e.g. from 1 to 5), where a low value indicates that the DU migration is not critical for the RAN node CUa 1002, while a high value indicates of the DU migration is critical for the RAN node CUa 1002, for instance because of some load issue associated to the processing or radio/network resources in the IAB topology controlled by the RAN node CUa 1002,
an indication related to the profile of the user traffic associated to the RAN node (e.g. traffic profile information for indicating a profile of user traffic associated with the RAN node), including QoS (Quality of Service) parameters, as defined in TS 38.423 V17.2.0 section 9.2.2.81. Each traffic profile may be identified by a traffic index,
an indication related to the throughput of the user traffic associated to the RAN node (e.g. traffic throughput information for indicating the throughput of user traffic associated with the RAN node), both in upstream (from the RAN node) and downstream direction (to the RAN node),
the number of UEs that would be handed over to the RAN node CUb 1002 together with the RAN node. In addition, the number of onboard UEs may be indicated (i.e. UEs inside the vehicle equipped with the IAB-node or otherwise surrounding and moving with the IAB-node).

The RAN Node DU 1001 may acknowledge the request with the message CONFIGURATION RESPONSE 1004 sent to the RAN Node CU 1002. The message 1004 may be used to report to the RAN node CU 1002 the status of the F1 connection with the target F1 RAN node CU.

In case of successful F1 setup for the DU migration of the RAN node, it means that the target F1 RAN node CU has (fully or partially) accepted the DU migration. Then, the message 1004 may include an Information Element (IE) (e.g. second DU gNB-DU ID), to identify the activated logical DU in the RAN node. In case of partial acceptance of DU migration, the message 1004 may include the cause of the partial acceptance.

In case of unsuccessful F1 setup for the DU migration of the RAN node, it means that the target F1 RAN node CU has rejected or revoked the DU migration. In this latter case, the message 1004 may include the cause (e.g. cause information) of the rejection or revocation as described with reference to the message 812 in the FIG. 8.

According to one example, the flow in FIG. 10a corresponds to the procedure gNB-CU Configuration Update procedure described in TS 38.473 V17.0.0 section 8.2.5, and amended with the information elements and the behavior described above. The message 1003 corresponds to the message GNB-CU CONFIGURATION UPDATE described in TS 38.473 V17.2.0 section 9.2.1.10, while the message 1004 corresponds to the message GNB-CU CONFIGURATION UPDATE ACKNOWLEDGE described in TS 38.473 V17.2.0 section 9.2.1.11.

FIG. 10b is a simplified diagram illustrating an example message flow, according to one or more embodiments of the invention, of a procedure to setup a logical DU in a RAN node, including the signaling to partially accept, reject or revoke a DU migration of the RAN node by a RAN node CU.

This figure shows:
a RAN node DU 1011 of a RAN node, that may be a DU of an IAB-node DU like IAB-DU 572 of IAB node 570 of FIG. 5 (and IAB-DU2 806 of IAB node 801 of FIG. 8),
a RAN node CU 1012, that may be an IAB-Donor-CU like IAB-donor-CU 503 of FIG. 5 (and target F1 donor-CU 807 of FIG. 8).

The message SETUP REQUEST 1013 is sent by the RAN node DU 1011 to the RAN node CU 1012 to request the F1 setup for the logical DU. For example, SETUP REQUEST 1013 may be sent by the IAB node (e.g. by the second logical DU entity 806 which has been activated at the IAB node 801) to the target IAB donor CU 807 for requesting set up of a F1 connection between a target IAB donor CU and the IAB node (e.g. with the second logical DU entity 806 of the IAB node 801). SETUP REQUEST 1013 may correspond to request 814 described above with reference to FIG. 8, which is a F1 setup request for requesting the setup of the F1 connection and for indicating the F1 connection to be established relates to a request for DU migration of the IAB node 801 to the target IAB donor CU. The SETUP REQUEST message 1013 may be sent after an activation request as described with reference to FIG. 10a. This SETUP REQUEST message 1013 may include the number of cells to be activated along with activation of the logical DU. This SETUP REQUEST message 1013 may include the indication that it is related to the DU migration of the RAN node and it may include all or part of the context of the DU migration (e.g. context information) as described with reference to the message 1003 of the FIG. 10a.

The message 1013 may also include the TNL address (i.e. the IP address) and/or the identifier (i.e. Global NG-RAN Node ID as specified in TS 38.423 V17.2.0 section 9.2.2.3) of the source RAN node CU that has requested the F1 setup,

The RAN node CU 1012 answers with the message SETUP RESPONSE 1014 sent to the RAN node DU 1011. SETUP RESPONSE 1014 may correspond to response 815 described above with reference to FIG. 8, which is a F1 setup response for indicating the target IAB donor CU has accepted or rejected the F1 setup request relating to the request for DU migration to the target IAB donor CU. The RAN node CU 1012 may accept or reject the F1 setup request. If the F1 setup request is related to the DU migration of an IAB-node, the F1 setup request may be accepted by the RAN node CU 1012 if the DU migration of the IAB-node is (fully or partially) accepted, or the F1 setup request may be rejected by the RAN node CU 1012 if the DU migration of the IAB-node is rejected or the F1 setup request may be revoked by the RAN node CU 1012 if the DU migration of the IAB-node has been previously accepted and then revoked. The decision by the RAN node CU 1012 may be based on the information related to the context of the DU migration (if context information is included in the message 1013). In case of (full or partial) acceptance, the RAN node CU 1012 may include a list of cell(s) to activate with the logical DU, along with the associated PCI and NCGI value(s) to be used. In case of partial acceptance, rejection or revocation, the RAN node CU 1012 may indicate (e.g. via cause information included in the message 1014) the cause of the partial acceptance, rejection or revocation as described above with respect to the message 812. In case of partial acceptance, the response may include the identification of the part of the traffic that is accepted (e.g. the index(es) of the accepted traffic profile(s)), and/or the number of UEs that are accepted.

According to one example, the flow in FIG. 10b corresponds to the procedure F1 setup described in TS 38.473 V17.2.0 section 8.2.3, amended with the information elements and the behavior described above. The message 1013 may correspond to the message F1 SETUP REQUEST described in TS 38.473 V17.2.0 section 9.2.1.4. The message 1014 may correspond to the message F1 SETUP RESPONSE described in TS 38.473 V17.2.0 section 9.2.1.5, if the RAN node CU 1012 has accepted the request (e.g. when the RAN node CU 1012 has (fully or partially) accepted the DU migration of the RAN node), while the message 1014 may correspond to the message F1 SETUP FAILURE described in TS 38.473 V17.2.0 section 9.2.1.6, if the RAN node CU 1012 has rejected the request (e.g. when the RAN node CU 1012 has rejected the DU migration of the RAN node).

FIG. 10c is a simplified diagram 1020 illustrating an example message flow of a procedure to remove a logical DU.

This figure shows:
a RAN node DU 1021 of a RAN node, that may be a DU of an IAB-node DU like IAB-DU 572 of IAB node 570 of FIG. 5 (and IAB-DU1 805 of IAB node 801 of FIG. 8),
a RAN node CU 1022, that may be an IAB-Donor-CU like IAB-donor-CU 501 of FIG. 5 (and source F1 donor-CU 803 of FIG. 8).

The message REMOVAL REQUEST 1023 is sent by the RAN node CU 1022 to the RAN node DU 1021 to request the removal (which is equivalent to deactivation) of the logical DU.

The RAN node DU 1021 answers with the message REMOVAL RESPONSE 1014 sent to the RAN node CU 1022.

According to one example, the flow in FIG. 10c corresponds to the procedure F1 removal described in TS 38.473 V17.2.0 section 8.2.8, and the message 1023 corresponds to the message F1 REMOVAL REQUEST described in TS 38.473 V17.2.0 section 9.2.1.16, while the message 1024 corresponds to the message F1 REMOVAL RESPONSE described in TS 38.473 V17.2.0 section 9.2.1.7.

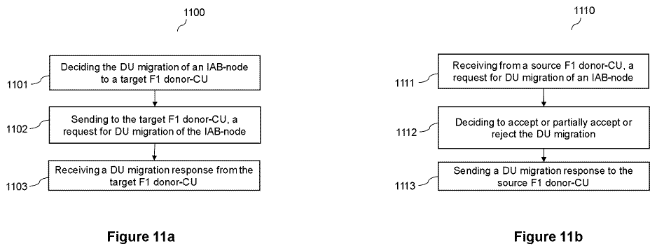

FIG. 11a is a flowchart of an example method 1100 in accordance with embodiments of the present invention, for managing, at the source F1 terminating donor-CU of an IAB-node, the DU migration of the IAB-node. For example, method 1100 in accordance with embodiments of the present invention is performed at the source IAB donor CU and is for use in managing, or as part of, a migration process/procedure for migrating a DU of an IAB node from the source IAB donor CU to a target IAB donor CU.

For example, with reference to the IAB communication system 500 shown in and described with respect to FIG. 5, the source IAB donor CU performing the method 1100 may be the IAB donor CU 501 (e. g a F1 terminating donor CU or F1 donor-CU of the IAB node 570 with which the IAB node 570 retains a F1 connection). The IAB node may be the mobile IAB-node 570 belonging to IAB topology 5001 (also referred to as source IAB topology) controlled by the IAB donor CU 501. The migration process may involve the migration of the DU 572 of the IAB node 570 from IAB topology 5001 to IAB topology 5003 (also referred to as target IAB topology) managed by IAB donor CU 503 which is the target IAB donor CU. With reference to FIGS. 7 and 8, the IAB node may be IAB-node 701, 801 and the migration process may involve the migration of the DU of the IAB-node 701, 801 from the source F1 terminating donor-CU 703, 803 to the target F1 terminating donor-CU 707, 807. The method 1100 as shown in and described with respect to FIG. 11a may be performed by software elements and/or hardware elements. The source IAB donor CU may be implemented in a communication device 400 as shown in and described with reference to FIG. 4 with the method as shown in and described with respect to FIG. 11a being performed by an apparatus for the source IAB donor CU including one or more processing units, such as the central processing unit 411.

At step 1101, the source F1 terminating donor-CU, like the donor-CU 501 of FIG. 5 (703, 803), determines that the DU of the IAB node, like the IAB-node 570 of FIG. 5 (701, 801) is to be migrated from the source F1 donor-CU 501, 703, 803 to a target F1 terminating donor-CU, like the donor-CU 503 of FIG. 5 (707, 807). For example, the source F1 terminating donor-CU 501, 703, 803 decides the DU migration of an IAB-node, like the IAB-node 570, toward a target F1 donor-CU, like the donor-CU 503, 707, 807. For example, the source F1 donor-CU 501, 703, 803 may determine that the DU 572 of the IAB node 570, 701, 801 is to be migrated in response to determining the migration of the MT 571, 704, 804 of the IAB node 570, 701, 801 toward a new parent IAB node (which may be a new IAB node or a new IAB donor DU) has been completed. Examples of other triggers for determining the DU is to be migrated are described above. Details of how the source F1 terminating donor-CU 501, 703, 803 determines the target F1 terminating donor-CU 503, 707, 807 is also described above.

At step 1102, the source F1 terminating donor-CU 501, 703, 803 sends to the target F1 terminating donor-CU 503, 707, 807 a request for DU migration of the IAB node (e.g. a request for requesting DU migration of the DU of the IAB node 570, 701, 801 from the source F1 terminating donor-CU 501, 703, 803 to the target F1 terminating donor-CU 503, 707, 807). The message sent at step 1102 may be a migration request message such as the message 811 in FIG. 8.

At step 1103, the source F1 terminating donor-CU 501, 703, 803 receives from the target F1 donor-CU 503, 707, 807 a response indicating if the target F1 terminating donor-CU 503, 707 (fully or partially) accepts or rejects the DU migration of the IAB node. The message received at step 1103 may be a migration response message such as the message 812 in FIG. 8. As discussed above, the response received at step 1103 may include CU cause information for indicating the cause of the partial acceptance or rejection of the request for DU migration to the target donor CU. In case of partial acceptance, the response may include the identification of the part of the traffic that is accepted (e.g. the index(es) of the accepted traffic profile(s)), and/or the number of UEs that are accepted.

When the target F1 terminating donor-CU 503, 707, 807 determines to partially accept or to reject the DU migration of the IAB node 570, 701, 801, the response indicates the target F1 terminating donor-CU 503, 707, 807 has partially accepted or rejected the request for DU migration. After receiving (or in response to receiving) a rejection response, the migration process is not executed or execution of the migration process is terminated (e.g. the source IAB donor CU does not send a DU activation request 813). After rejection or partial acceptance, the source IAB donor-CU may decide to postpone the DU migration and to make a new attempt later, or it may decide to select another target donor-CU.

In the case the DU migration is (fully or partially) accepted by the target F1 donor-CU 503, 707, 807, the response received at the source F1 terminating donor-CU 501, 703, 803 indicates the target F1 donor-CU 503, 707, 807 has (fully or partially) accepted the DU migration and in response, the source F1 terminating donor-CU 501, 703, 803 may initiate the migration process which is then executed (e.g. the steps described above with reference to FIG. 7 are performed).

FIG. 11b is a flowchart of an example method 1110 in accordance with embodiments of the present invention, for managing, at the target F1 terminating donor-CU of an IAB-node, the DU migration of the IAB-node. For example, method 1110 in accordance with embodiments of the present invention is performed at the target IAB donor CU and is for use in managing, or as part of, a migration process/procedure for migrating a DU of an IAB node from a source IAB donor CU to the target IAB donor CU.

For example, with reference to the IAB communication system 500 shown in and described with respect to FIG. 5, the target IAB donor CU performing the method 1110 may be the IAB donor CU 503 which controls IAB topology 5003. The IAB node may be the mobile IAB-node 570 belonging to IAB topology 5001 controlled by the IAB donor CU 501. The migration process may involve the migration of the DU 572 of the IAB node 570 from IAB topology 5001 to IAB topology 5003. With reference to FIGS. 7 and 8, the IAB node may be IAB-node 701, 801 and the migration process may involve the migration of the DU of the IAB-node 701, 801 from the source F1 terminating donor-CU 703, 803 to the target F1 donor-CU 707, 807. The method 1110 as shown in and described with respect to FIG. 11b may be performed by software elements and/or hardware elements. The target IAB donor CU may be implemented in a communication device 400 as shown in and described with reference to FIG. 4 with the method as shown in and described with respect to FIG. 11b being performed by an apparatus for the target IAB donor CU including one or more processing units, such as the central processing unit 411.

At step 1111, the target F1 terminating donor-CU, like the donor-CU 503 of FIG. 5 (707, 807), receives a request for requesting DU migration of the DU of the IAB node 570, 701, 801 from the source F1 terminating donor CU to the target F1 terminating donor CU.

The request may be sent as a DU migration request from the source F1 terminating donor CU, such as IAB donor CU 501 of FIG. 5 (703, 803) to request the DU migration of the IAB node 570, 701, 801 in the IAB topology controlled by the target F1 terminating donor-CU 503, 707, 807. The message received at step 1111 may be the message 811 in FIG. 8.

At step 1112, the target F1 terminating donor-CU 503, 707, 807 determines if it (fully) accepts or partially accepts or rejects the DU migration of the IAB-node 570, 701, 801. The decision may be based on the current load of processing resources of the target F1 terminating donor-CU 503, 707, 807, or on the current load of network resources (wired backhaul and/or wireless backhaul) in the IAB topology managed by the target F1 terminating donor-CU 503, 707, 807. To assist the decision by the target F1 terminating donor-CU 503, 707, 807 may use the information related to the context of the DU migration included in the message received at step 1111 (e.g. context information as described above with respect to message 811).

At step 1113, the target F1 terminating donor-CU 503, 707, 807 sends to the source F1 donor-CU 501, 703, 803 a response indicating if the target F1 terminating donor-CU 503, 707 (fully or partially) accepts or rejects the DU migration of the IAB node 570, 701, 801. The message sent at step 1113 may be the message 812 in FIG. 8. After the target F1 terminating donor-CU 503, 707, 807 determines to partially accept or to reject the DU migration of the IAB node 570, 701, 801, the response indicates the target F1 terminating donor-CU 503, 707, 807 has partially accepted or rejected the request for DU migration.

As discussed above, although not shown in FIGS. 11a and 11b, after determining to (fully or partially) accept the request for DU migration, the target F1 donor-CU 503, 707, 807 may determine to revoke DU migration of the IAB node to the target F1 donor-CU 503, 707, 807 (e.g. when the target F1 donor-CU 503, 707, 807 cannot support the DU migration (and any served UEs). In this case, the target F1 donor-CU 503, 707, 807 sends a revocation response (e.g. a message such as message 914), to the source F1 donor-CU 501, 703, 803 indicating the target F1 donor-CU 503, 707, 807 has determined to revoke the DU migration of the IAB node to the target F1 donor-CU 503, 707, 807.

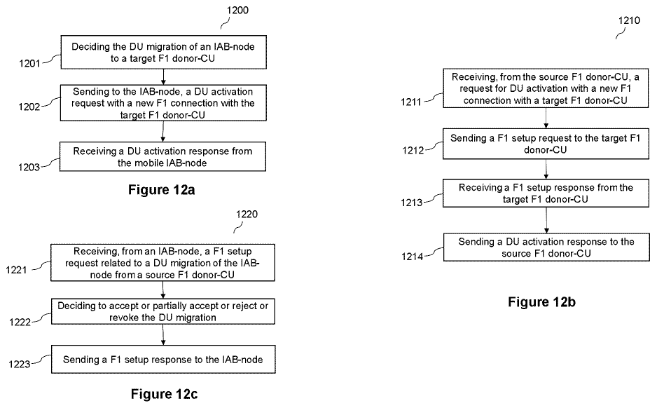

FIG. 12a is a flowchart of another example method 1200 in accordance with embodiments of the present invention, for managing, at the source F1 terminating donor-CU of an IAB-node, the DU migration of the IAB-node. For example, method 1200 in accordance with embodiments of the present invention is performed at the source IAB donor CU and is for use in managing, or as part, of a migration process/procedure for migrating a DU of an IAB node from the source IAB donor CU to a target IAB donor CU.

For example, with reference to the IAB communication system shown 500 in and described with respect to FIG. 5, the source IAB donor CU performing the method 1200 may be the IAB donor CU 501 (e. g a F1 terminating donor CU or F1 donor-CU of the IAB node 570 with which the IAB node 570 retains a F1 connection). The IAB node may be mobile IAB-node 570 belonging to IAB topology 5001 (also referred to as source IAB topology) controlled by the IAB donor CU 501. The migration process may involve the migration of the DU 572 of the IAB node 570 from IAB topology 5001 to IAB topology 5003 (also referred to as target IAB topology) managed by IAB donor CU 503 which is the target IAB donor CU. With reference to FIGS. 7 and 8, the IAB node may be IAB-node 701, 801 and the migration process may involve the migration of the DU of the IAB-node 701, 801 from the source F1 terminating donor-CU 703, 803 to the target F1 terminating donor-CU 707, 807. The method 1200 as shown in and described with respect to FIG. 12a may be performed by software elements and/or hardware elements. The source IAB donor CU may be implemented in a communication device 400 as shown in and described with reference to FIG. 4 with the method as shown in and described with respect to FIG. 12a being performed by an apparatus for the source IAB donor CU including one or more processing units, such as the central processing unit 411.

At step 1201, the source F1 terminating donor-CU, like the donor-CU 501 of FIG. 5 (703, 803), determines that the DU of the IAB node, like the IAB-node 570 of FIG. 5 (701, 801) is to be migrated from the source F1 terminating donor-CU 501, 703, 803 to a target F1 terminating donor-CU, like the donor-CU 503 of FIG. 5 (707, 807). For example, the source F1 terminating donor-CU 501, 703, 803 decides the DU migration of an IAB-node, like the IAB-node 570, 701, 801, toward a target F1 terminating donor-CU, like the donor-CU 503, 707, 807. For example, the source F1 terminating donor-CU 501, 703, 803 may determine that the DU of the IAB node 570, 701, 801 is to be migrated in response to determining the migration of the MT 571, 704, 804 of the IAB node 570, 701, 801 toward a new parent IAB node (which may be a new IAB node or a new IAB donor DU) has been completed. Examples of other triggers for determining the DU is to be migrated are described above. Details of how the source F1 donor-CU 501, 703, 803 determines the target F1 terminating donor-CU 503, 707, 807 is also described above.

At step 1202, the source F1 terminating donor-CU 501, 703, 803 sends to the IAB-node 570, 701, 801 a request for establishing a F1 connection (i.e. a new F1 connection) between the target IAB donor CU 503, 707, 807 and the IAB-node 570, 701, 801 (e.g. a new F1 association with the target IAB donor CU) and for informing the target IAB donor CU that the F1 connection is related to a DU migration of the IAB-node 570, 701, 801. The request from the source F1 terminating donor-CU 501, 703, 803 may indicate (explicitly via an IE or implicitly) to the IAB-node 570, 701, 801 that the IAB node is to inform the target IAB donor CU 503, 707, 807 that the F1 connection is related to the DU migration of the IAB-node 570, 701, 801. The request may also inform the target IAB donor CU 503, 707, 807 of the context of the DU migration as described above. For example, the request may include the context information as described above with respect to message 811. The request may indicate (explicitly via an IE or implicitly) that the IAB-node 570, 701, 801 is to transmit the context of the DU migration (which may also be included in the request) to the target IAB donor CU 503, 707, 807. The message sent at step 1202 may be the message 813 in FIG. 8.

Not represented in the FIG. 12a, the source F1 terminating donor-CU 501, 703, 803 may have executed the procedure described with the FIG. 9b before the step 1202, and it may have received the acceptance of the DU migration by the target IAB donor CU 503, 707, 807 (e.g. in a migration response 914).

At step 1203, the source F1 terminating donor-CU 501, 703, 803 receives a response indicating whether the target IAB donor CU 503, 707, 807 has (fully) accepted or partially accepted or rejected (or revoked if the target IAB donor CU 503, 707, 807 has previously accepted the DU migration of the IAB-node 570, 701, 801) the request for DU migration to the target IAB donor CU 503, 707, 807. The response may be a DU activation response from the IAB-node 570, 701, 801. The message received at step 1203 may be the message 816 shown in and described with respect to FIG. 8.

In the case when the target IAB donor CU 503, 707, 807 has rejected or revoked the request for DU migration of the IAB-node 570, 701, 801, the response 816 indicates the target IAB donor CU has rejected the request for establishing a F1 connection between the target IAB donor CU 503, 707, 807 and the IAB-node 570, 701, 801 and hence has rejected or revoked the request for DU migration of the IAB-node 570, 701, 801. The response 816 may include cause information for indicating the cause of the rejection of the request for DU migration to the target donor CU as described above with respect to the message 812. In case of partial acceptance of the DU migration (with acceptance of the F1 setup request), the response 816 may include the cause of partial acceptance.

In another example (not shown in FIG. 12a), when the target IAB donor CU 503, 707, 807 has rejected or revoked the DU migration of the IAB-node 570, 701, 801 and thus rejected setting up a F1 connection between the target IAB donor CU 503, 707, 807 and the IAB-node 570, 701, 801, the source F1 terminating donor-CU 501, 703, 803 may receive a response indicating the target IAB donor CU 503, 707, 807 has rejected or revoked the request for DU migration to the target IAB donor CU 503, 707, 807 from the target F1 donor-CU 807 with, for instance, the procedure described at the FIG. 9a. Such a response may also include cause information for indicating the cause of the rejection or revocation of the request for DU migration to the target donor CU as described above. In case of partial acceptance of the DU migration (with acceptance of the F1 setup request), the target F1 donor-CU 807 may inform the source F1 donor-CU 803 about the cause of partial acceptance.

After receiving (or in response to receiving) a rejection/revocation response, the migration process is not executed or execution of the migration process is terminated (e.g. the source IAB donor CU does not send a DU activation request 813). After rejection/revocation, the source IAB donor-CU may decide to postpone the DU migration and to make a new attempt later, or it may decide to select another target donor-CU.

FIG. 12b is a flowchart of an example method 1210 in accordance with embodiments of the present invention, for managing, at an IAB-node its DU migration to a target F1 terminating donor-CU. For example, method 1210 in accordance with embodiments of the present invention is performed at the IAB node and is for use in, or as part of, managing a migration process/procedure for migrating a DU of an IAB node from a source IAB donor CU to a target IAB donor CU.

For example, with reference to the IAB communication system shown 500 in and described with respect to FIG. 5, the IAB node performing the method 1210 may be the mobile IAB-node 570 belonging to IAB topology 5001 (also referred to as source IAB topology) controlled by the IAB donor CU 501 (e.g. a F1 terminating donor CU of the mobile IAB node 570 with which the mobile IAB node 570 retains a F1 connection) which is the source IAB donor CU. The migration process may involve the migration of the DU 572 of the IAB node 570 from IAB topology 5001 to IAB topology 5003 (also referred to as target IAB topology) managed by IAB donor CU 503 which is the target IAB donor CU. With reference to FIGS. 7 and 8, the IAB node may be mobile IAB-node 701, 801 and the migration process may involve the migration of the DU of the IAB-node 701, 801 from the source F1 terminating donor-CU 703, 803 to the target F1 terminating donor-CU 707, 807. The method 1210 as shown in and described with respect to FIG. 12b may be performed by software elements and/or hardware elements. The IAB node may be implemented in a communication device 400 as shown in and described with reference to FIG. 4 with the method as shown in and described with respect to FIG. 12b being performed by an apparatus for the IAB node including one or more processing units, such as the central processing unit 411.

At step 1211, an IAB-node, like the IAB-node 570 of FIG. 5 (701, 801), receives from a source F1 terminating donor-CU, like the donor-CU 501 of FIG. 5 (703, 803), a request for establishing a F1 connection or a new F1 connection (for example, a F1 connection between the IAB-node 570, 701, 801 and a target F1 donor CU, like the donor-CU 503 of FIG. 5 (707, 807)) and for informing the target IAB donor CU that the F1 connection is related to the DU migration of the IAB-node 570, 701, 801. The request from the source F1 terminating donor-CU 501, 703, 803 may indicate (explicitly or implicitly) to the IAB-node 570, 701, 801 that the IAB node is to inform the target IAB donor CU 503, 707, 807 that the F1 connection is related to the DU migration of the IAB-node 570, 701, 801. The request may also inform the target F1 donor CU 807 of the context of the DU migration as described above. For example, the request may include the context information as described above with respect to message 811. The request may indicate (explicitly or implicitly) that the IAB-node 570, 701, 801 is to provide or transmit the context of the DU migration (which may also be included in the request) to the target IAB donor CU 503, 707, 807. The message received at step 1211 may be the message 813 in FIG. 8.

At step 1212, in response to (or after) receiving a request for a new F1 connection, the IAB node 570, 701, 801 then sends, to the target F1 terminating donor CU 503, 707, 807, a Fl setup request requesting the setup of the F1 connection and indicating the F1 connection to be established relates to a request for DU migration of the IAB node 570, 701, 801 to the target F1 terminating donor CU 503, 707, 807. For example, the F1 setup request message sent by the IAB node 570, 701, 801 may include an indication that the F1 connection to establish is related to the DU migration of the IAB node 570, 701, 801. It may also include part of or all the context of the DU migration (such as all or part of the context information described above). The message sent at the step 1212 may be the message 814 in FIG. 8.

At step 1213, the IAB node 570, 701, 801 receives, from the target F1 terminating donor CU 503, 707, 807, a F1 setup response message. This message indicates whether the target F1 terminating donor CU 503, 707, 807 accepts or rejects the F1 setup request. The decision to accept or to reject the F1 setup request may be linked to the decision to (fully or partially) accept or to reject (or to revoke if the target IAB donor CU 503, 707, 807 has previously accepted DU migration of the IAB node 570, 701, 801) the DU migration of the IAB node 570, 701, 801. The message received at the step 1213 may be the message 815 in FIG. 8. In case of rejection or revocation, the F1 setup response indicates the target F1 terminating donor CU 503, 707, 807 has rejected the F1 setup request relating to the request for DU migration to the target F1 terminating donor CU 503, 707, 807. In this case, the F1 setup response may also indicate (e.g. via cause information included in the message 815) the cause of the rejection or revocation of the DU migration as described above with respect to the message 812. In case of partial acceptance of DU migration (with acceptance of the F1 setup request), the F1 setup response may indicate the cause of partial acceptance of the DU migration.

At step 1214, the IAB-node 570, 701, 801 sends to the source F1 terminating donor-CU 501, 703, 803 a DU activation response. This message indicates the status of the F1 connection establishment with the target F1 terminating donor CU 503, 707, 807. It may relay the decision by the target F1 terminating donor CU 503, 707, 807 to (fully or partially) accept or to reject or to revoke the DU migration of the IAB-node 570, 701, 801. The message sent at step 1214 may be the message 816 shown in and described with respect to FIG. 8.

In the case when the target IAB donor CU 503, 707, 807 has rejected or revoked the request for DU migration of the IAB-node 570, 701, 801, the response 816 indicates the target IAB donor CU has rejected the request for establishing a F1 connection between the target IAB donor CU 503, 707, 807 and the IAB-node 570, 701, 801 and hence has rejected or revoked the request for DU migration of the IAB-node 570, 701, 801. The response 816 may include cause information for indicating the cause of the rejection or revocation of the request for DU migration to the target donor CU as described above with respect to the message 812. In case of partial acceptance of DU migration (with acceptance of the F1 setup request), the response 816 may indicate the cause of partial acceptance of the DU migration.

FIG. 12c is a flowchart of another example method 1220 in accordance with embodiments of the present invention, for managing, at a target F1 terminating donor-CU of an IAB-node, the DU migration of the IAB-node. For example, method 1220 in accordance with embodiments of the present invention is performed at the target IAB donor CU and is for use in managing, or as part of, a migration process/procedure for migrating a DU of an IAB node from a source IAB donor CU to the target IAB donor CU.

For example, with reference to the IAB communication system 500 shown in and described with respect to FIG. 5, the target IAB donor CU performing the method 1220 may be the IAB donor CU 503 which controls IAB topology 5003. The IAB node may be the mobile IAB-node 570 belonging to IAB topology 5001 controlled by the IAB donor CU 501. The migration process may involve the migration of the DU 572 of the IAB node 570 from IAB topology 5001 to IAB topology 5003. With reference to FIGS. 7 and 8, the IAB node may be IAB-node 701, 801 and the migration process may involve the migration of the DU of the IAB-node 701, 801 from the source F1 terminating donor-CU 703, 803 to the target F1 donor-CU 707, 807. The method 1220 as shown in and described with respect to FIG. 12c may be performed by software elements and/or hardware elements. The target IAB donor CU may be implemented in a communication device 400 as shown in and described with reference to FIG. 4 with the method as shown in and described with respect to FIG. 12c being performed by an apparatus for the target IAB donor CU including one or more processing units, such as the central processing unit 411.

At step 1221, the target F1 terminating donor-CU, like the donor-CU 503 of FIG. 5 (707, 807), receives, from the IAB node 570, 701, 801, a F1 setup request requesting the setup of the F1 connection and indicating the F1 connection to be established relates to a request for DU migration of the IAB node 570, 701, 801 to the target F1 terminating donor CU 503, 707, 807. For example, the F1 setup request message sent by the IAB node 570, 701, 801 may include an indication that the F1 connection to establish is related to the DU migration of the IAB node IAB node 570, 701, 801. It may also include part of or all the context of the DU migration (such as all or part of the context information described above). The message received at the step 1221 may be the message 814 in FIG. 8.

At step 1222, the target F1 terminating donor-CU 503, 707, 807 determines if it (fully) accepts or partially accepts or rejects (or revokes if it has previously accepted the DU migration of the IAB-node 570, 701, 801) the DU migration of the IAB-node 570, 701, 801, and thus the F1 setup request. The decision may be based on the current load of processing resources of the target F1 terminating donor-CU 503, 707, 807, or on the current load of network resources (wired backhaul and/or wireless backhaul) in the IAB topology managed by the target F1 terminating donor-CU 503, 707, 807. To assist the decision by the target F1 terminating donor-CU 503, 707, 807 may use the information related to the context of the DU migration included in the message received at step 1221.

After determining whether to (fully or partially) accept or reject/revoke DU migration, the target F1 terminating donor-CU 503, 707, 807 sends a response indicating whether the target IAB donor CU 503, 707, 807 has (fully or partially) accepted or rejected/revoked the request for DU migration to the target IAB donor CU 503, 707, 807. For example, at step 1223, the target F1 terminating donor-CU 503, 707, 807 sends to the IAB-node 570, 701, 801 a response indicating if the target F1 terminating donor-CU 503, 707 (fully or partially) accepts or rejects or revokes the DU migration of the IAB-node 570, 701, 801, and thus accepts or rejects the F1 setup request of the IAB node 570, 701, 801. The message sent at step 1223 may be the message 815 in FIG. 8.

In an alternative example (not shown in FIG. 12c), the target F1 terminating donor-CU 503, 707, 807 sends a response to the source F1 terminating donor-CU 501, 703, 803 (e.g. with the procedure described at the FIG. 9a) indicating whether the target IAB donor CU 503, 707, 807 has (fully or partially) accepted or rejected or revoked the request for DU migration to the target IAB donor CU 503, 707, 807. Such a response may also include cause information for indicating the cause of the partial acceptance/rejection/revocation of the request for DU migration to the target donor CU as described above.

In case of rejection or revocation, the response, whether a F1 setup response sent to the IAB-node 570, 701, 801 or a response sent to the source F1 terminating donor-CU 501, 703, 803, indicates the target F1 terminating donor CU 503, 707, 807 has rejected the F1 setup request relating to the request for DU migration to the target F1 terminating donor CU 503, 707, 807. In this case, the response may also indicate (e.g. via cause information) the cause of the rejection or revocation of the DU migration as described above.

Thus, the method/apparatus in accordance with one or more embodiments of the present invention enables the target IAB donor CU to partially accept, reject or revoke the DU migration (and thus, the subsequent handover of UEs served by the IAB node) in the case the target IAB donor CU is not able to accommodate the IAB node DU and the traffic related to the served UEs (because of some lack of processing resources, or some lack of radio/network resources) and to inform the source IAB donor CU so that appropriate action can be taken. With the target IAB donor CU sending a response to the source IAB donor CU to indicate the DU migration has been (fully or partially) accepted or rejected, triggering activation of a second logical DU in the IAB node when DU migration is rejected can be avoided. With the target IAB donor CU sending a response to the IAB node to indicate the DU migration has been (fully or partially) accepted or rejected, the F1 setup procedure will have already been completed which saves setup time when DU migration is accepted.

In other words and as a summary, about acceptance/rejection of DU migration, it can be observed that when the DU of a mobile IAB-node is migrated from a source F1 donor-CU toward a target F1 donor-CU, the UEs served by the mobile IAB-node shall also be handed over toward this target F1 donor-CU. Upon reception of a handover request for a UE served by the mobile IAB-node, the target F1 donor-CU may reject the handover. If this happens, the cause of handover preparation failure should not be related to the radio network layer as the traffic associated to the UE is handled by the non-F1 donor-CU (or RRC terminating donor-CU) serving the co-located mobile IAB-MT. However, the cause may be a control processing overload as a CU can handle a limited number of connected UEs. In case only a few donor-CUs support mobile IAB, those donor-CUs would handle many mobile IAB-nodes and thus many UEs.

A situation where most handovers of UEs served by a mobile IAB-node are rejected by the target F1 donor-CU should be avoided, as these UEs, and especially the onboard UEs, will have to be handed over to another cell and they will lose the benefit of the mobile cell. Thus, it may be useful to get the status at the target F1 donor-CU before initiating the first UE handover.

For this purpose, the F1 setup request in the scope of a DU migration may include an information related to the number of UEs served by the mobile IAB-node. This information would help the target donor-CU for the decision to accept or to reject the F1 setup request (due to control processing overload). In case of rejection, another target donor-CU may be selected, or a new attempt may be performed later.

Then, it is proposed that in the scope of DU migration of a mobile IAB-node, the F1 setup request sent to the target F1 donor-CU may include the number of connected UEs served by the mobile IAB-node.

Besides, the target F1 donor-CU may be allowed to partially accept the DU migration. For instance, the target F1 donor-CU may partially accept the DU migration in the F1 setup response by indicating the number of UEs it can accommodate.

Then, it is proposed that the target F1 donor-CU may accept the DU migration of a mobile IAB-node with some conditions, e.g. with a maximum number of UEs that can be served.

While the present invention has been described with reference to examples and embodiments, it is to be understood that the invention is not limited to the disclosed examples and embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave may be included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1.-19. (canceled)

20. A method for use in a migration process for migrating a Distributed Unit, DU, of an Integrated Access Backhaul, IAB, node, from a source F1 terminating IAB donor Central Unit, CU, to a target F1 terminating IAB donor CU, the method at the target F1 terminating IAB donor CU comprising:
receiving, from the IAB node, a F1 setup request message for requesting setup of a F1 connection between the target F1 terminating IAB donor CU and the IAB node in a case where the DU of the IAB node is to be migrated to the target F1 terminating IAB donor CU;
sending a F1 setup response message indicating the target F1 terminating IAB donor CU has determined to accepted F1 setup or sending a F1 setup failure message indicating the target F1 terminating IAB donor CU has rejected F1 setup.

21. The method of claim 20, wherein sending includes sending, to the IAB node, the F1 setup response message or the F1 setup failure message.

22. (canceled)

23. The method of claim 20, wherein sending comprises: sending the F1 setup failure message indicating the target F1 terminating IAB donor CU has rejected the F1 setup for DU migration to the target F1 terminating IAB donor CU.

24. The method of claim 20, wherein in a case where the F1 setup failure message is sent the F1 setup failure message includes cause information for indicating the cause of the rejection of the F1 setup.

25. The method of claim 20, wherein sending comprises: sending the F1 setup response message indicating the target F1 terminating IAB donor CU has accepted the F1 setup for DU migration to the target F1 terminating IAB donor CU.

26.-31. (canceled)

32. A method for use in a migration process for migrating a Distributed Unit, DU, of an Integrated Access Backhaul, IAB, node from a source F1 terminating IAB donor Central Unit, CU, to a target F1 terminating IAB donor CU, the method at the source F1 terminating IAB donor CU comprising:
in a case where the DU of the IAB node is to be migrated to the target F1 terminating IAB donor CU;
sending, to the IAB node, a request for establishing a F1 connection between the target F1 terminating IAB donor CU and the IAB node;
receiving a response indicating the target F1 terminating IAB donor CU has accepted F1 connection establishment between the target F1 terminating IAB donor CU and the IAB node or rejected F1 connection establishment between the target F1 terminating IAB donor CU and the IAB node.

33. (canceled)

34. The method of claim 32, wherein receiving a response comprises: receiving, from the IAB node, a response indicating the target F1 terminating IAB donor CU has accepted or rejected F1 connection establishment between the target F1 terminating IAB donor CU and the IAB node.

35. (canceled)

36. The method of claim 32, wherein receiving comprises: receiving a response indicating the target F1 terminating IAB donor CU has rejected F1 connection establishment for DU migration to the target F1 terminating IAB donor CU.

37. (canceled)

38. The method of claim 36, further comprising: after receiving a response indicating the target F1 terminating IAB donor CU has rejected F1 connection establishment, terminating execution of the migration process for migrating the DU of the IAB node to the target F1 terminating IAB donor CU.

39. The method of claim 32, wherein receiving comprises: receiving a response indicating the target F1 terminating IAB donor CU has accepted F1 connection establishment for DU migration to the target F1 terminating IAB donor CU.

40.-41. (canceled)

42. A method for use in a migration process for migrating a Distributed Unit, DU, of an Integrated Access Backhaul, IAB, node from a source F1 terminating IAB donor Central Unit, CU, to a target F1 terminating IAB donor CU, the method at the IAB node comprising:
receiving, from the source F1 terminating IAB donor CU, a request for establishing a F1 connection between the target F1 terminating IAB donor CU and the IAB node;
sending, to the target F1 terminating IAB donor CU, a F1 setup request message for requesting setup of the F1 connection;
receiving a F1 setup response message indicating the target F1 terminating IAB donor CU has accepted the F1 setup or receiving a F1 setup failure message indicating the target F1 terminating IAB donor CU has rejected the F1 setup.

43. (canceled)

44. The method of claim 42, further comprising: sending, to the source F1 terminating IAB donor CU, a response indicating the target F1 terminating IAB donor CU has accepted F1 connection establishment between the target F1 terminating IAB donor CU and the IAB node or rejected F1 connection establishment between the target F1 terminating IAB donor CU and the IAB node.

45. The method of claim 42, wherein receiving a F1 setup failure message comprises: receiving a F1 setup failure message indicating the target F1 terminating IAB donor CU has rejected the F1 setup for DU migration to the target F1 terminating IAB donor CU.

46. The method of claim 42, wherein the F1 setup failure message includes cause information for indicating the cause of the rejection of the F1 setup.

47. (canceled)

48. The method of claim 42, wherein receiving a F1 setup response message comprises: receiving a F1 setup response message indicating the target F1 terminating IAB donor CU has accepted the F1 setup request for DU migration to the target F1 terminating IAB donor CU.

49.-53. (canceled)

54. The method of claim 42, wherein the request for establishing a F1 connection includes context information relating to the context of DU migration to the target F1 terminating IAB donor CU.

55. The method of claim 54, wherein the request indicates the IAB node is to provide at least some of the context information to the target F1 terminating IAB donor CU.

56. The method of claim 42, wherein the F1 setup request message includes context information relating to the context of DU migration to the target F1 terminating IAB donor CU.

57. The method of claim 56, wherein the context information includes one or more of:
identification information for identifying the IAB node;
identification information for identifying RRC terminating IAB donor CU serving the Mobile Termination, MT, of the IAB node;
priority information for indicating a level of priority for the request for DU migration;
traffic profile information for indicating a profile of user traffic associated with the IAB node;
traffic throughput information for indicating the throughput of user traffic associated with the IAB node;
User Equipment, UE, information for indicating a number of UEs served by the IAB node; or
onboard UE information for indicating a number of onboard UEs served by the IAB node.

58. The method of claim 56, wherein the context information includes: information known by an RRC terminating IAB donor CU serving the MT of the IAB node for identifying the IAB node.

59. An apparatus for an Integrated Access Backhaul, IAB, donor Central Unit, CU, of an IAB communication system, the apparatus comprising:
one or more processing units configured to, in the case where the IAB donor CU is operating as a target F1 terminating IAB donor CU:
receive, from an Integrated Access Backhaul, IAB, node, a F1 setup request message for requesting setup of a F1 connection between the target F1 terminating IAB donor CU and the IAB node in a case where a Distributed Unit, DU, of the IAB node is to be migrated from a source F1 terminating IAB donor CU to the target F1 terminating IAB donor CU;
send a F1 setup response message indicating the target F1 terminating IAB donor CU has accepted F1 setup or send a F1 setup failure message indicating the target F1 terminating IAB donor CU has rejected F1 setup.

60. An apparatus for an Integrated Access Backhaul, IAB, node of an IAB communication system, the apparatus comprising:
one or more processing units configured to, in a case where a Distributed Unit, DU, of an Integrated Access Backhaul, IAB, node is to be migrated from a source F1 terminating IAB donor Central Unit, CU, to a target F1 terminating IAB donor CU:
receive, from the source F1 terminating IAB donor CU, a request for establishing a F1 connection between the target F1 terminating IAB donor CU and the IAB node;
send, to the target F1 terminating IAB donor CU, a F1 setup request message for requesting setup of the F1 connection;
receive a F1 setup response message indicating the target F1 terminating IAB donor CU has accepted the F1 setup or receive a F1 setup failure message indicating the target F1 terminating IAB donor CU has rejected the F1 setup.

61. (canceled)

62. A non-transitory computer-readable storage medium carrying a computer program comprising program instructions which, when the computer program is executed by one or more processing units of an Integrated Access and Backhaul, IAB, node, cause the IAB node to, in a case where a Distributed Unit, DU, of the IAB node is to be migrated from a source F1 terminating IAB donor Central Unit, CU, to a target F1 terminating IAB donor CU:
receive, from the source F1 terminating IAB donor CU, a request for establishing a F1 connection between the target F1 terminating IAB donor CU and the IAB node;
send, to the target F1 terminating IAB donor CU, a F1 setup request message for requesting setup of the F1 connection;
receive a F1 setup response message indicating the target F1 terminating IAB donor CU has accepted the F1 setup or receive a F1 setup failure message indicating the target F1 terminating IAB donor CU has rejected the F1 setup.

63. The method of claim 20, wherein the F1 setup request message includes one or more of:
identification information for identifying the IAB node;
information for identifying a RRC terminating IAB donor CU serving a Mobile Termination, MT, of the IAB node, the RRC terminating IAB donor CU terminating the RRC connection of the IAB node and being a different IAB donor CU to the target F1 terminating IAB donor CU; or
information for identifying a Mobile Termination, MT, of the IAB node in the case where a RRC terminating IAB donor CU terminating the RRC connection of the IAB node is a different IAB donor CU to the target F1 terminating IAB donor CU.

64. The method of claim 20, wherein in a case where a first condition is satisfied, the F1 setup response message indicating the target F1 terminating IAB donor CU has accepted the F1 setup is transmitted from the target F1 terminating IAB donor CU, and in a case where a second condition different from the first condition is satisfied, the F1 setup failure message indicating the target F1 terminating IAB donor CU has rejected the F1 setup is transmitted from the target F1 terminating IAB donor CU.

65. The method of claim 42, wherein the F1 setup request message includes one or more of:
identification information for identifying the IAB node;
information for identifying a RRC terminating IAB donor CU serving a Mobile Termination, MT, of the IAB node, the RRC terminating IAB donor CU terminating the RRC connection of the IAB node and being a different IAB donor CU to the target F1 terminating IAB donor CU; or
information for identifying a Mobile Termination, MT, of the IAB node in the case where a RRC terminating IAB donor CU terminating the RRC connection of the IAB node is a different IAB donor CU to the target F1 terminating IAB donor CU.

66. The method of claim 42, wherein the IAB node is a mobile IAB-node mounted on a vehicle.

67. The apparatus of claim 59, wherein the one or more processing units are configured to send, to the IAB node, the F1 setup response message or the F1 setup failure message.

68. The apparatus of claim 59, wherein in a case where the F1 setup failure message is sent, the F1 setup failure message includes cause information for indicating the cause of the rejection of the F1 setup.

69. The apparatus of claim 59, wherein the F1 setup request message includes one or more of:
identification information for identifying the IAB node;
information for identifying a RRC terminating IAB donor CU serving a Mobile Termination, MT, of the IAB node, the RRC terminating IAB donor CU terminating the RRC connection of the IAB node and being a different IAB donor CU to the target F1 terminating IAB donor CU; or
information for identifying a Mobile Termination, MT, of the IAB node in the case where a RRC terminating IAB donor CU terminating the RRC connection of the IAB node is a different IAB donor CU to the target F1 terminating IAB donor CU.

70. The apparatus of claim 59, wherein in a case where a first condition is satisfied, the F1 setup response message indicating the target F1 terminating IAB donor CU has accepted the F1 setup is transmitted from the target F1 terminating IAB donor CU, and in a case where a second condition different from the first condition is satisfied, the F1 setup failure message indicating the target F1 terminating IAB donor CU has rejected the F1 setup is transmitted from the target F1 terminating IAB donor CU.

71. The apparatus of claim 60, wherein the one or more processing units are configured to: send, to the source F1 terminating IAB donor CU, a response indicating the target F1 terminating IAB donor CU has accepted F1 connection establishment between the target F1 terminating IAB donor CU and the IAB node or rejected F1 connection establishment between the target F1 terminating IAB donor CU and the IAB node.

72. The apparatus of claim 60, wherein the F1 setup failure message includes cause information for indicating the cause of the rejection of the F1 setup.

73. The apparatus of claim 60, wherein the request for establishing a F1 connection includes context information relating to the context of DU migration to the target F1 terminating IAB donor CU.

74. The apparatus of claim 73, wherein the context information includes one or more of:
identification information for identifying the IAB node;
identification information for identifying a RRC terminating IAB donor CU serving the Mobile Termination, MT, of the IAB node;
priority information for indicating a level of priority for the request for DU migration;
traffic profile information for indicating a profile of user traffic associated with the IAB node;
traffic throughput information for indicating the throughput of user traffic associated with the IAB node;
User Equipment, UE, information for indicating a number of UEs served by the IAB node; or
onboard UE information for indicating a number of onboard UEs served by the IAB node.

75. The apparatus of claim 60, wherein the F1 setup request message includes one or more of:
identification information for identifying the IAB node;
information for identifying a RRC terminating IAB donor CU serving a Mobile Termination, MT, of the IAB node, the RRC terminating IAB donor CU terminating the RRC connection of the IAB node and being a different IAB donor CU to the target F1 terminating IAB donor CU; or
information for identifying a Mobile Termination, MT, of the IAB node in the case where a RRC terminating IAB donor CU terminating the RRC connection of the IAB node is a different IAB donor CU to the target F1 terminating IAB donor CU.
